(19) United States
(12) Patent Application Publication
(10) Pub. No.: US 2017/0176614 A1
(43) Pub. Date: Jun. 22, 2017

(54) Acquisition and Regularization of Non-Uniform Seismic Data

(71) Applicant: Saudi Arabian Oil Company, Dhahran (SA)

(72) Inventors: Ibrahim Abdulaziz Alhukail, College Station, TX (US); Luc Ikelle, Bryan, TX (US)

(73) Assignees: Saudi Arabian Oil Company, Dhahran (SA); The Texas A&M University System, College Station, TX (US)

(21) Appl. No.: 15/451,814

(22) Filed: Mar. 7, 2017

Related U.S. Application Data
(63) Continuation-in-part of application No. 14/981,065, filed on Dec. 28, 2015.
Application No. 14/981,065 is a division of application No. 13/225,067, filed on Sep. 2, 2011, now Pat. No. 9,354,337.
Application No. 13/225,067 is a continuation of application No. 13/032,109, filed on Feb. 22, 2011, now abandoned.
(60) Provisional application No. 62/304,792, filed on Mar. 7, 2016.
(60) Provisional application No. 61/306,657, filed on Feb. 22, 2010.

(51) Int. Cl. G01V 1/30; G01V 1/36; G01V 1/00

(52) U.S. Cl. CPC G01V 1/30; G01V 1/003; G01V 1/36; G01V 2210/57; G01V 2210/74; G01V 2210/1295; G01V 2210/1425

(57) ABSTRACT

Provided in some embodiments are systems and associated methods for regularizing seismic data. Embodiment include obtaining non-uniformly sampled seismic data (e.g., generated by real seismic sensor array having an un-even distribution of real seismic sensors physically positioned proximate a subsurface formation), interpolating the non-uniformly sampled seismic data (e.g., using a Lagrange interpolation or non-linear interpolation) to generate regularized seismic data representing a regular distribution of seismic sensors, and generating, using the regularized seismic data, a seismic image of the subsurface formation.

### RELATED APPLICATIONS

This application claims priority to U.S. Provisional Patent Application No. 62/304,792 filed Mar. 7, 2016, titled “Seismic Data Regularization” and is a continuation-in-part of U.S. patent application Ser. No. 14/981,065, filed on Dec. 28, 2015, titled “System, Machine, and Computer-Readable Storage Medium for Forming and Enhanced Seismic Trace Using a Virtual Seismic Array,” which is a divisional of U.S. patent application Ser. No. 13/225,067, filed on Sep. 2, 2011, titled “System, Machine, and Computer-Readable Storage Medium for Forming an Enhanced Seismic Trace Using a Virtual Seismic Array” (now U.S. Pat. No. 9,354,337), which is a continuation of U.S. patent application Ser. No. 13/032,109, filed on Feb. 22, 2011, titled “System, Machine, and Computer-Readable Storage Medium for Forming an Enhanced Seismic Trace Using a Virtual Seismic Array” (now abandoned), which claims priority to U.S. Provisional Patent Application No. 61/306,657 filed Feb. 22, 2010, titled “System, Machine, Program Product, and Computer-Implemented Method for Forming an Enhanced Seismic Trace Using a Virtual Seismic Array.” Each of these related applications is incorporated herein by reference in its entirety.

### FIELD OF DISCLOSURE

The embodiments described relate generally to seismology, and more particularly to regularizing non-uniformly sampled seismic data.

### BACKGROUND

Hydrocarbon deposits are often trapped thousands of feet below the Earth's surface. For example, oil and gas can be trapped in hydrocarbon reservoirs located in underground rock formations (also referred to as “subsurface formations”). Exploration for hydrocarbons typically employs seismology techniques, such as seismic imaging, for locating and assessing hydrocarbon reservoirs. Seismic imaging includes imaging the geological structure of subsurface formations in an effort to locate geologic features indicative of hydrocarbon reservoirs. Seismic imaging generally involves emitting waves of seismic energy (e.g., sound waves) that propagate into the subsurface formation, sensing reflected waves of seismic energy (e.g., sound waves that are reflected from the subsurface formation) (also referred to as “echoes”), and assessing the reflected waves to generate seismic images of the subsurface formation.

The waves of seismic energy are typically generated from an energy source (e.g., an explosive or a vibrating device), and are at least partially reflected by portions the subsurface formation (e.g., subterranean matter) having divergent impedances. When a wave of seismic energy encounters a boundary between materials of different impedances (e.g., a boundary between different rock layers), at least some of the energy is reflected off the boundary, resulting in the reflected echoes. These echoes can be sensed by seismic sensors (also referred to as “seismic receivers”) (e.g., geophones disposed at the Earth's surface above the subsurface formation, geophones disposed in boreholes drilled into the subsurface formation, or hydrophones suspended in a body of water above the subsurface formation), and the seismic sensors can record waveform data corresponding to the echoes sensed. The waveform data recorded by a seismic sensor can include, for example, time-series data that includes an indication of an arrival time of the respective echoes and variations in the magnitude (or “intensity”) of the echoes over time. The recorded data can be processed to determine characteristics of the subsurface formation, such as depths and physical properties of geological structures in the subsurface formation. For example, changes in signal properties can be processed to identify changes in seismic impedances at certain locations in the subsurface formation, and the changes in seismic impedances can be used to determine locations and properties (e.g., density and elastic modulus) of underlying geologic structures of the subsurface formation, which can, in-turn be processed to generate a three-dimensional digital model of the subsurface formation, such as a three-dimensional seismic image of the subsurface formation.

Seismic images are often used to generate models of formations, including three-dimensional representations of the various features of the subsurface formations. These models can be used, for example, to identify locations of hydrocarbon reservoirs (e.g., oil and gas reservoirs) in formations. Moreover, these models and the identified locations of hydrocarbon reservoirs can be used as a basis for a field development plan which can, for example, identify locations for drilling wells to produce the hydrocarbons and even wellbore paths (also referred to as “well trajectories”) for the respective wells. Ultimately, wells (e.g., production, injection and monitoring wells) can be drilled and operated according to the field development plan to efficiently produce the hydrocarbons from the reservoirs. Thus, seismic imaging can provide a key element in discovering and developing hydrocarbon reservoirs.

In the context of seismic imaging, resulting seismic images can be of higher or lower resolution depending on characteristics of the seismic data acquisition and processing techniques employed. For example, a relatively large number of seismic sensors can be deployed in an area to produce relatively high resolution seismic images of the underlying formation. Relatively high resolution seismic images can enable seismic features to be distinguished from one another (also referred to as being “resolved”). In contrast, relatively low resolution seismic images may not enable certain seismic features to be resolved. That is, the features may appear as one feature or otherwise be indistinguishable from one another (referred to as being “merged” features). For example, in un-enhanced resolution seismic images, structures such as stratigraphic traps may appear only as un-resolved bright spots. Thus, features that are resolved in a relatively high resolution seismic image of an area may be unresolved in a relatively low resolution seismic image of the same area. Unfortunately, oil and gas exploration can be limited by the quality of seismic images. For example, relatively low resolution seismic images that lack sufficient resolution to resolve subtle or nuanced geological structures and phenomena indicative of locations of hydrocarbon reservoirs may inhibit the ability to locate the hydrocarbon reservoirs. As a result, areas that include producible hydrocarbons may not be identified.

Conventional seismic acquisition systems use an array of strategically positioned seismic sensors. The seismic sensors are sometimes referred to as “seismic receivers”, and the array of seismic sensors is often referred to as a “seismic sensor array” or “seismic receiver array”. A seismic sensor array typically includes 6 to 24 seismic sensors used to record seismic response data corresponding to echoes, and the recorded seismic response data is processed to produce seismic images. For example, the recorded data for each seismic sensor of a seismic sensor array can be summed for a particular time (t) to produce a seismic response (also known as a “seismic trace”) for the seismic sensor. Conventional seismic imaging systems often perform the summation using hardwired logic so that all wave fronts recorded by the seismic sensors at a time (t) are directly summed irrespective of the data quality or any potential sensor malfunction. The resulting seismic traces can be assembled to generate corresponding seismic images. As described, such seismic images can be used to generate model of the structure and physical properties of subsurface formations. Unfortunately, the results obtained are usually not unique, as more than one model can be found to adequately fit the data. Therefore, a paramount consideration in seismology is to measure the echoes in a way that most accurately and completely captures the true geologic subsurface properties of the subsurface formation, and to extract from those measurements as much information as possible to accurately and completely represent the true geologic structure of the subsurface formation.

### SUMMARY

Applicants have recognized that seismic data acquisition often involves attempting to produce non-aliased wavefields sampled at equidistant intervals. This way of sampling wavefields is known as “uniform sampling” or “regular sampling”, and the techniques for reconstructing continuous wavefields from uniform samples are well known (See, e.g., Ikelle, Luc and Lasse Amundsen. Introduction to Petroleum Seismology (Investigations in Geophysics No. 12). SEG Books, 2005). Applicants have also recognized that, despite the reliance on uniform sampling, the sampling of seismic data can be inherently non-uniform. For example, seismic sensors may be positioned in non-uniformly (or irregularly) shaped arrays due to physical constraints that prevent them from being positioned in a uniformly (or regularly) shaped arrays. In land-based seismic data acquisition the physical topography of the Earth's surface can prevent seismic sensors from being placed in some areas. Some areas (e.g., jungles) can have geographic limitations that prevent the placement of seismic sensors in certain locations; some areas (e.g., urban areas and areas of existing hydrocarbon production installations) can have existing structures (e.g., buildings) that prevent the placement of seismic sensors in certain locations; and some areas can have regulations (e.g., government regulations) that prevent the placement of seismic sensors in certain locations. In ocean bottom seismic (OBS) based seismic data acquisition, topography of the ocean-floor can prevent the placement of seismic sensors in certain locations. In towed-streamer based seismic data acquisition, cable feathering can cause seismic sensors locations to drift from their desired locations. Applicants have recognized that, non-uniform sampling (e.g., using non-uniform seismic sensor arrays) can reduce the cost and complexity of seismic data acquisition. For example, if the requirement for a uniform seismic sensor array is removed, a seismic survey operator may be able to forgo positioning one more seismic sensors in locations where it is impractical to do so, thereby avoiding the cost and complexity of having to position the one more seismic sensors in the locations to form a uniform seismic sensor array.

With regard to current seismic data acquisition and processing techniques, Applicants have recognized that existing seismic imaging techniques (e.g., Fourier analysis) often rely on uniformly sampled seismic data, and cannot provide suitable results when used to process non-uniformly sampled seismic data. Applicants have also recognized that, although hardwired summation to generate seismic traces (e.g., summing the data for a particular time (t) to produce a seismic trace for a seismic sensor) can be efficient in terms of acquisition speed and turnaround time, it is susceptible to errors and inaccuracies that can cause an inaccurate and incomplete representations the true geological structure of the subsurface formation. For example, the resulting seismic traces can include contributions from noise leakage due to aliasing, improper summation due to malfunctioning sensors, the introduction of non-geologic seismic effects, seismic source and sensor variation, coherent noises, and electrical noise or spikes. Although certain conventional systems attempt to provide corrective functions (e.g., filtering the collected data for noise and aliased data, correcting for actual or potential sensor malfunctions, and correcting for any non-geologic seismic effects prior to summing the data), these techniques do not account for non-uniform sampling using non-uniform seismic sensor arrays. Notably, the industry trend has been to employ dense sampling, including deploying an increased number of seismic sensors in an effort to improve the seismic data acquired. For example, some approaches include significantly increasing the number of seismic sensors (e.g., by a factor 2× or even more than 10×) and reducing the spacing between the seismic sensors of the seismic sensor array to acquire a relatively large and dense set of seismic data for use in generating seismic images. This is typically done for sensing surface waves with source generated noise, which is dispersive and characterized by high amplitudes, broad ranges of frequencies. Unfortunately, this can increase the costs to acquire, store and process the increased amount of seismic data. The increase in costs can be attributed to, for example, the costs of the increased number of seismic sensors, the time, effort and costs required to position the increased number of seismic sensors, as well as the processing and storage overhead required to store and process the increased amount of seismic data.

Recognizing these and other shortcomings of existing systems, Applicants have developed novel systems and associated methods for acquiring and processing seismic data. In some embodiments, virtual array techniques are employed to generate a “virtual” seismic sensor array that includes data representative of seismic data acquired via real seismic sensors of a real seismic sensor array, and additional data generated to represent virtual seismic sensors. As a result, the virtual seismic sensor array can provide a representation of an extended area that is larger than an area covered by the real seismic sensor array (e.g., including virtual sensors that extend beyond the area covered by the real seismic sensors of the real seismic sensor array) and/or can provide an enhanced seismic image of the area covered by the real seismic sensors of the real seismic sensor array (e.g., including representations for virtual sensors located in gaps between the real seismic sensors of the real seismic sensor array). That is, the virtual sensor array can include a representation of a greater number of seismic sensors (e.g., including real and virtual seismic sensors) relative to the number of real seismic sensors of the real seismic sensor array used to acquire the corresponding seismic data. Such virtual array techniques can be employed with uniform seismic sensor arrays (e.g., including real seismic sensors distributed evenly) or non-uniform seismic sensor array (e.g., including real seismic sensors distributed un-evenly). In some embodiments, the non-uniform real seismic sensor array can include a non-uniform physical distribution of real seismic sensors, such as a non-uniform linear, grid, circle or star distribution of real seismic sensors on the Earth's surface.

In some embodiments, data regularization techniques are employed to regularize non-uniform seismic data (e.g., seismic data acquired via a non-uniform real seismic sensor array). The data regularization techniques can include acquiring non-uniform seismic data via a non-uniform seismic sensor array (e.g., with or without derivatives of the sampled components of the sensed seismic echoes), interpolating the non-uniformly sampled seismic data (e.g., using a Lagrange interpolation or non-linear interpolation) to generate regularized seismic data representing a regular distribution of seismic sensors, and generating a seismic image of the subsurface formation using the regularized seismic data. In some embodiments, the non-uniform seismic data is processed to generate virtual seismic sensor array data, and the virtual seismic sensor array data is subjected to the interpolation (e.g., in place of the non-uniformly sampled seismic data) to generate the regularized seismic data. Embodiments employ a new Lagrange series for use with non-uniform sampling and aliased data.

In some embodiments, compressive sensing techniques are employed to provide data regularization for sparsely sampled seismic data. Sparsely sampled seismic data can include seismic data acquired via a seismic sensor array having relatively large physical spacings (e.g., greater than 16 meters (m)) between seismic sensors of the array. Such an array may be referred to as a sparse seismic sensor array. The compressive sensing techniques can include obtaining non-uniform aliased multi-component signal responses via a sparse real seismic sensor array having a first non-uniform large spacing between the real seismic sensors of the real seismic sensor array, generating a mixing-matrix that is time-independent, conducting an optimization operation (e.g., a least-squares optimization operation or sparse optimization operation) based on the signal responses and the mixing-matrix to generate uniform (“regularized”) seismic data corresponding to a uniform seismic sensor array having a second spacing between the seismic sensors of the seismic sensor array that is less than the first spacing of the real seismic sensor array, and generating a seismic image of a subsurface formation based on the regularized seismic data. In other words, compressive sensing can enable the generation of data corresponding to a relatively small seismic sensor spacing using data acquired via a sparse real seismic sensor array having a large seismic sensor spacing. There are often periods of time (or “gaps”) when there is nothing of significance being sensed by the seismic sensors, for example, during periods between seismic events. These gaps can be indicated by corresponding zeros in the seismic data. Compressive sensing takes advantages of these gaps. Unfortunately, during seismic sensing these gaps are very short. Embodiments employ a “dictionary” (e.g., a mapping) that accounts for the lack of significant gaps. For example, the dictionary can include a mapping of seismic data that is not sparse enough for compressive sensing (e.g., it does not have a significant amount gaps such that less than 5% of the seismic data is represented by zeros indicating no seismic event being sensed) to a space where the data is relatively sparse (e.g., 60% or more of the seismic data is represented by zeros indicating no seismic event being sensed). In some embodiments, the compressive sensing techniques include generating a dictionary configured to increase a sparse representation of data and determining a second mixing-matrix based on the (first) mixing-matrix and the dictionary, generating reconstructed data based on the second mixing-matrix, and generating the regularized seismic data based on the dictionary and the reconstructed data.

Accordingly, certain embodiments provide for generating virtual seismic sensors that can fill-in gaps between real seismic sensors of a real seismic sensor array, certain embodiments provide for regularizing data obtained via non-uniform and sparse seismic sensor arrays. Embodiments can provide for generating regularized data (e.g., non-aliased data corresponding to a seismic sensor array having equidistant seismic sensor spacings) from non-uniform aliased data (e.g., aliased data acquired via a real seismic sensor array having uneven or non-equidistant seismic sensor spacings) and, in some embodiments, the real or virtual seismic sensor array can be sparse (e.g., the spacings of the seismic receivers of the array being relatively large). In some embodiments, one or more of the described techniques can be used in combination to account for non-uniform and/or sparse real seismic sensor arrays. For example, seismic data can be acquired via a non-uniform and sparse real seismic sensor array, virtual sensors can be generated to fill-in gaps in the real seismic sensors, data regularization can be applied to account for any irregularities in the real seismic sensor array, and compressive sensing can be applied to account for the sparse spacing of the real seismic sensor array. Thus, in contrast to the industry trend to increase the number of seismic sensors in an effort to improve the seismic data acquired, Applicants have developed techniques that enable the use of relatively fewer seismic sensors to generate relatively high-resolution seismic images. Such techniques can enable acquiring seismic data at a relatively low cost, while still providing relatively high-resolution seismic images using the seismic data acquired at the relatively low cost.

Provided in some embodiments is a seismic imaging system that includes the following: a seismic energy source physically positioned proximate a subsurface formation, the seismic energy source adapted to emit waves of seismic energy into the subsurface formation; a non-uniform real seismic sensor array including an un-even distribution of real seismic sensors physically positioned proximate the subsurface formation, the real seismic sensors of the real seismic sensor array adapted to sense seismic echoes including reflections of the waves of seismic energy emitted into the subsurface formation and to generate signal responses corresponding to the seismic echoes sensed by the real seismic sensors of the non-uniform real seismic sensor array; and a seismic processing system including non-transitory computer readable storage medium including program instructions stored thereon that are executable by a processor to perform the following operations: obtaining non-uniformly sampled seismic data including the signal responses corresponding to the seismic echoes sensed by the real seismic sensors of the non-uniform real seismic sensor array; interpolating the non-uniformly sampled seismic data to generate regularized seismic data representing a regular distribution of seismic sensors; and generating, using the regularized seismic data, a seismic image of the subsurface formation.

In some embodiments, interpolating the non-uniformly sampled seismic data to generate regularized seismic data representing a regular distribution of seismic sensors includes conducting a Lagrange interpolation of the non-uniformly sampled seismic data to generate the regularized seismic data representing a regular distribution of seismic sensors. In certain embodiments, interpolating the non-uniformly sampled seismic data to generate regularized seismic data representing a regular distribution of seismic sensors includes conducting a non-linear interpolation of the non-uniformly sampled seismic data to generate the regularized seismic data representing a regular distribution of seismic sensors.

In some embodiments, the signal responses include multi-component recordings including one or more derivatives of each component of multiple components of the seismic echoes. In certain embodiments, the one or more derivatives include a first-order derivative. In some embodiments, the one or more derivatives include a first-order derivative and a second-order derivative. In certain embodiments, the one or more derivatives include a first-order derivative, a second-order derivative and a third-order derivative.

In some embodiments, interpolating the non-uniformly sampled seismic data to generate regularized seismic data representing a regular distribution of seismic sensors includes generating a virtual seismic sensor array including data corresponding to the real seismic sensors of the of the real seismic sensor array and virtual seismic sensors. In certain embodiments, generating a virtual seismic sensors array including data corresponding to the real seismic sensors of the of the real seismic sensor array and virtual seismic sensors includes: generating a complex envelope for each seismic signal response generated by the real seismic sensors; decomposing each complex envelope into one or more narrowband signals; determining fourth-order cross-cumulants for each of the narrowband signals for each of (I) statistically independent seismic signals; determining a virtual steering vector for each of the each of the (I) statistically independent seismic signals based on the fourth-order cross-cumulants; and determining enhanced seismic traces from the fourth-order cross-cumulants and the virtual steering vectors, wherein generating a seismic image of the subsurface formation includes generating the seismic image of the subsurface formation based on the enhanced seismic traces.

In some embodiments, the non-uniform real seismic sensor array includes a non-uniform linear distribution of the real seismic sensors. In certain embodiments, the non-uniform real seismic sensor array includes a non-uniform two-dimensional grid distribution of the real seismic sensors. In some embodiments, the non-uniform real seismic sensor array includes a non-uniform two-dimensional circular distribution of the real seismic sensors including the real seismic sensors unevenly distributed about concentric circles. In certain embodiments, the non-uniform real seismic sensor array includes a non-uniform two-dimensional star distribution of the real seismic sensors including the real seismic sensors unevenly distributed along radial lines.

Provided in some embodiments, is a seismic imaging method that includes the following: operating a seismic energy source physically positioned proximate a subsurface formation to emit waves of seismic energy into the subsurface formation; operating a non-uniform real seismic sensor array to generate non-uniformly sampled seismic data, the real seismic sensor array including an un-even distribution of real seismic sensors physically positioned proximate the subsurface formation, the real seismic sensors of the real seismic sensor array adapted to sense seismic echoes including reflections of waves of seismic energy emitted into the subsurface formation and to generate signal responses corresponding to the seismic echoes sensed by the real seismic sensors of the non-uniform real seismic sensor array, the non-uniformly sampled seismic data including the signal responses corresponding to the seismic echoes sensed by the real seismic sensors of the non-uniform real seismic sensor array; and a seismic processing system performing the following operations: obtaining the non-uniformly sampled seismic data including the signal responses corresponding to the seismic echoes sensed by the real seismic sensors of the non-uniform real seismic sensor array; interpolating the non-uniformly sampled seismic data to generate regularized seismic data representing a regular distribution of seismic sensors; and generating, using the regularized seismic data, a seismic image of the subsurface formation.

In certain embodiments, interpolating the non-uniformly sampled seismic data to generate regularized seismic data representing a regular distribution of seismic sensors includes conducting a Lagrange interpolation of the non-uniformly sampled seismic data to generate the regularized seismic data representing a regular distribution of seismic sensors. In some embodiments, interpolating the non-uniformly sampled seismic data to generate regularized seismic data representing a regular distribution of seismic sensors includes conducting a non-linear interpolation of the non-uniformly sampled seismic data to generate the regularized seismic data representing a regular distribution of seismic sensors.

In certain embodiments, the signal responses include multi-component recordings including one or more derivatives of each component of multiple components of the seismic echoes. In some embodiments, the one or more derivatives include a first-order derivative. In certain embodiments, the one or more derivatives include a first-order derivative and a second-order derivative. In some embodiments, the one or more derivatives include a first-order derivative, a second-order derivative and a third-order derivative.

In certain embodiments, interpolating the non-uniformly sampled seismic data to generate regularized seismic data representing a regular distribution of seismic sensors includes generating a virtual seismic sensor array including data corresponding to the real seismic sensors of the of the real seismic sensor array and virtual seismic sensors. In some embodiments, generating a virtual seismic sensors array including data corresponding to the real seismic sensors of the of the real seismic sensor array and virtual seismic sensors includes: generating a complex envelope for each seismic signal response generated by the real seismic sensors; decomposing each complex envelope into one or more narrowband signals; determining fourth-order cross-cumulants for each of the narrowband signals for each of (I) statistically independent seismic signals; determining a virtual steering vector for each of the each of the (I) statistically independent seismic signals based on the fourth-order cross-cumulants; and determining enhanced seismic traces from the fourth-order cross-cumulants and the virtual steering vectors, wherein generating a seismic image of the subsurface formation includes generating the seismic image of the subsurface formation based on the enhanced seismic traces.

In certain embodiments, the non-uniform real seismic sensor array includes a non-uniform linear distribution of the real seismic sensors. In some embodiments, the non-uniform real seismic sensor array includes a non-uniform two-dimensional grid distribution of the real seismic sensors. In certain embodiments, the non-uniform real seismic sensor array includes a non-uniform two-dimensional circular distribution of the real seismic sensors including the real seismic sensors unevenly distributed about concentric circles. In some embodiments, the non-uniform real seismic sensor array includes a non-uniform two-dimensional star distribution of the real seismic sensors including the real seismic sensors unevenly distributed along radial lines.

Provided in some embodiments is a seismic imaging system including: a seismic energy source physically positioned proximate a subsurface formation, the seismic energy source adapted to emit waves of seismic energy into the subsurface formation; a real seismic sensor array including real seismic sensors physically positioned proximate the subsurface formation, the real seismic sensors of the real seismic sensor array adapted to sense seismic echoes including reflections of the waves of seismic energy emitted into the subsurface formation and to generate multi-component signal responses corresponding to the seismic echoes sensed by the real seismic sensors of the real seismic sensor array, the real seismic sensor array having a first spacing between the real seismic sensors of the real seismic sensor array; and a seismic processing system adapted to perform the following operations: generating a mixing-matrix that is time-independent; conducting an optimization operation based on the multi-component signal responses and the mixing-matrix to generate regularized seismic data corresponding to a seismic sensor array having a second spacing between the seismic sensors of the seismic sensor array that is less than the first spacing of the real seismic sensor array; and generating a seismic image of the subsurface formation based on the regularized seismic data.

In certain embodiments, the optimization operation includes a least-squares optimization operation. In some embodiments, the optimization operation includes a sparse optimization operation.

In certain embodiments, the operations further include: generating a dictionary adapted to increase a sparse representation of data; determining a second mixing-matrix based on the mixing-matrix and the dictionary, and conducting an optimization operation based on the multi-component signal responses and the mixing-matrix to generate regularized seismic data includes conducting an optimization operation based on the second mixing-matrix to generate reconstructed data and generating the regularized seismic data based on the dictionary and the reconstructed data. In some embodiments, optimization operation includes a least-squares optimization operation. In certain embodiments, optimization operation includes a sparse optimization operation.

In some embodiments, the real seismic sensor array includes a uniform seismic sensor array including an even distribution of real seismic sensors physically positioned proximate the subsurface formation. In certain embodiments, the real seismic sensor array includes a non-uniform seismic sensor array including an un-even distribution of real seismic sensors physically positioned proximate the subsurface formation.

Provided in some embodiments is a seismic imaging method including: operating a seismic energy source physically positioned proximate a subsurface formation to emit waves of seismic energy into the subsurface formation; operating a real seismic sensor array to generate multi-component signal responses, the real seismic sensor array including real seismic sensors physically positioned proximate the subsurface formation, the real seismic sensors of the real seismic sensor array adapted to sense seismic echoes including reflections of the waves of seismic energy emitted into the subsurface formation, the multi-component signal responses corresponding to the seismic echoes sensed by the real seismic sensors of the real seismic sensor array, the real seismic sensor array having a first spacing between the real seismic sensors of the real seismic sensor array; and a seismic processing system performing the following operations: generating a mixing-matrix that is time-independent; conducting an optimization operation based on the multi-component signal responses and the mixing-matrix to generate regularized seismic data corresponding to a seismic sensor array having a second spacing between the seismic sensors of the seismic sensor array that is less than the first spacing of the real seismic sensor array; and generating a seismic image of the subsurface formation based on the regularized seismic data.

In certain embodiments, the optimization operation includes a least-squares optimization operation. In some embodiments, the optimization operation includes a sparse optimization operation.

In certain embodiments, the operations further include: generating a dictionary adapted to increase a sparse representation of data; determining a second mixing-matrix based on the mixing-matrix and the dictionary, and conducting an optimization operation based on the multi-component signal responses and the mixing-matrix to generate regularized seismic data includes conducting an optimization operation based on the second mixing-matrix to generate reconstructed data and generating the regularized seismic data based on the dictionary and the reconstructed data. In some embodiments, the optimization operation includes a least-squares optimization operation. In certain embodiments, the optimization operation includes a sparse optimization operation.

In some embodiments, the real seismic sensor array includes a uniform seismic sensor array including an even distribution of real seismic sensors physically positioned proximate the subsurface formation. In certain embodiments, the real seismic sensor array includes a non-uniform seismic sensor array including an un-even distribution of real seismic sensors physically positioned proximate the subsurface formation.

Provided in some embodiments is non-transitory computer readable medium including program instructions stored thereon that are executable by a processor to perform the operations of the above described methods for seismic imaging.

### BRIEF DESCRIPTION OF THE DRAWINGS

FIG. 1 is a diagram that illustrates an example seismic imaging environment in accordance with one or more embodiments.

FIGS. 2A-2E are diagrams that illustrate example distributions of seismic sensor arrays in accordance with one more embodiments.

FIGS. 3A-3B are diagrams that illustrate example responses for seismic sensor arrays in accordance with one more embodiments.

FIGS. 4-6 illustrate example shot gathers in accordance with one or more embodiments.

FIG. 7 illustrates a mixing-matrix in accordance with one or more embodiments.

FIG. 8 illustrates example shot gathers in accordance with one or more embodiments.

FIG. 9 illustrates example eigenvalues in accordance with one or more embodiments.

FIG. 10 illustrates example shot gathers in accordance with one or more embodiments.

FIG. 11A illustrates an example dictionary in accordance with one or more embodiments.

FIG. 11B illustrates an example mixing-matrix in accordance with one or more embodiments.

FIG. 12 illustrates example stochastic coefficients in accordance with one or more embodiments.

FIGS. 13 and 14 illustrate example shot gathers in accordance with one or more embodiments.

FIGS. 15 is a flowchart that illustrates an example method for generating enhanced seismic images in accordance with one or more embodiments.

FIG. 16 is a flowchart that illustrates an example method for generating enhanced seismic images utilizing virtual arrays in accordance with one or more embodiments.

FIG. 17 is a flowchart that illustrates an example method for generating enhanced seismic images utilizing data regularization in accordance with one or more embodiments.

FIG. 18 is a flowchart that illustrates an example method for generating enhanced seismic images utilizing compressive sensing in accordance with one or more embodiments.

FIG. 19 is a diagram that illustrates an example computer system in accordance with one or more embodiments.

While this disclosure is susceptible to various modifications and alternative forms, specific embodiments are shown by way of example in the drawings and will be described in detail. The drawings may not be to scale. It should be understood that the drawings and the detailed descriptions are not intended to limit the disclosure to the particular form disclosed, but are intended to disclose modifications, equivalents, and alternatives falling within the spirit and scope of the present disclosure as defined by the claims.

### DETAILED DESCRIPTION

Described are embodiments of systems and methods for acquiring (or “sampling”) and processing seismic data. Certain embodiments describe acquiring and regularizing non-uniformly sampled seismic data. This can include, for example, acquiring non-uniform seismic data via non-uniform seismic sensor arrays and converting the non-uniform seismic data to uniform seismic data, similar to that of seismic data acquired using uniform seismic sensor arrays. As described herein, in some embodiments, a seismic data regularization can employ multi-component data, a virtual array, interpolation (e.g., Lagrange or non-linear), and/or optimization (e.g., a least-squares optimization operation or sparse optimization operation). Such techniques can provide for regularizing of recorded wavefields non-uniform seismic sensor distributions and/or with large spacing or gaps in seismic sensor distributions. It may also be effective for recording aliased wavefields. The results of such data regularization can be used to obtain non-aliased data, to remove some noise in the data, and/or to improve seismic image resolution.

In some embodiments, virtual array techniques are employed to generate a “virtual” seismic sensor array that includes data representative of seismic data acquired via real seismic sensors of a real seismic sensor array, and additional data generated to represent virtual seismic sensors. As a result, the virtual seismic sensor array can provide a representation of an extended area that is larger than an area covered by the real seismic sensor array (e.g., including virtual sensors that extend beyond the area covered by the real seismic sensors of the real seismic sensor array) and/or can provide an enhanced seismic image of the area covered by the real seismic sensors of the real seismic sensor array (e.g., including representations for virtual sensors located in gaps between the real seismic sensors of the real seismic sensor array). That is, the virtual sensor array can include a representation of a greater number of seismic sensors (e.g., including real and virtual seismic sensors) relative to the number of real seismic sensors of the real seismic sensor array used to acquire the corresponding seismic data. Such virtual array techniques can be employed with uniform seismic sensor arrays (e.g., including real seismic sensors distributed evenly) or non-uniform seismic sensor array (e.g., including real seismic sensors distributed un-evenly). In some embodiments, the non-uniform real seismic sensor array can include a non-uniform physical distribution of real seismic sensors, such as a non-uniform linear, grid, circle or star distribution of real seismic sensors on the Earth's surface.

In some embodiments, data regularization techniques are employed to regularize non-uniform seismic data (e.g., seismic data acquired via a non-uniform real seismic sensor array). The data regularization techniques can include acquiring non-uniform seismic data via a non-uniform seismic sensor array (e.g., with or without derivatives of the sampled components of the sensed seismic echoes), interpolating the non-uniformly sampled seismic data (e.g., using a Lagrange interpolation or non-linear interpolation) to generate regularized seismic data representing a regular distribution of seismic sensors, and generating a seismic image of the subsurface formation using the regularized seismic data. In some embodiments, the non-uniform seismic data is processed to generate virtual seismic sensor array data, and the virtual seismic sensor array data is subjected to the interpolation (e.g., in place of the non-uniformly sampled seismic data) to generate the regularized seismic data. Embodiments employ a new Lagrange series for use with non-uniform sampling and aliased data.

In some embodiments, compressive sensing techniques are employed to provide data regularization for sparsely sampled seismic data. Sparsely sampled seismic data can include seismic data acquired via a seismic sensor array having relatively large physical spacings (e.g., greater than 16 meters (m)) between seismic sensors of the array. Such an array may be referred to as a sparse seismic sensor array. The compressive sensing techniques can include obtaining non-uniform aliased multi-component signal responses via a sparse real seismic sensor array having a first non-uniform large spacing between the real seismic sensors of the real seismic sensor array, generating a mixing-matrix that is time-independent, conducting an optimization operation (e.g., a least-squares optimization operation or sparse optimization operation) based on the signal responses and the mixing-matrix to generate uniform (“regularized”) seismic data corresponding to a uniform seismic sensor array having a second spacing between the seismic sensors of the seismic sensor array that is less than the first spacing of the real seismic sensor array, and generating a seismic image of a subsurface formation based on the regularized seismic data. In other words, compressive sensing can enable the generation of data corresponding to a relatively small seismic sensor spacing using data acquired via a sparse real seismic sensor array having a large seismic sensor spacing. There are often periods of time (or “gaps”) when there is nothing of significance being sensed by the seismic sensors, for example, during periods between seismic events. These gaps can be indicated by corresponding zeros in the seismic data. Compressive sensing takes advantages of these gaps. Unfortunately, during seismic sensing these gaps are very short. Embodiments employ a “dictionary” (e.g., a mapping) that accounts for the lack of significant gaps. For example, the dictionary can include a mapping of seismic data that is not sparse enough for compressive sensing (e.g., it does not have a significant amount gaps, that is less than 5% of the seismic data is represented by zeros indicating no seismic event being sensed) to a space where the data is relatively sparse (e.g., 60% or more of the seismic data is represented by zeros indicating no seismic event being sensed). In some embodiments, the compressive sensing techniques include generating a dictionary configured to increase a sparse representation of data and determining a second mixing-matrix based on the (first) mixing-matrix and the dictionary, generating reconstructed data based on the second mixing-matrix, and generating the regularized seismic data based on the dictionary and the reconstructed data

Accordingly, certain embodiments provide for generating virtual seismic sensors that can fill-in gaps between real seismic sensors of a real seismic sensor array, certain embodiments provide for regularizing data obtained via non-uniform and sparse seismic sensor arrays. Embodiments can provide for generating regularized data (e.g., non-aliased data corresponding to a seismic sensor array having equidistant seismic sensor spacings) from non-uniform aliased data (e.g., aliased data acquired via a real seismic sensor array having uneven or non-equidistant seismic sensor spacings) and, in some embodiments, the real or virtual seismic sensor array can be sparse (e.g., the spacings of the seismic receivers of the array being relatively large). In some embodiments, one or more of the described techniques can be used in combination to account for non-uniform and/or sparse real seismic sensor arrays. For example, seismic data can be acquired via a non-uniform and sparse real seismic sensor array, virtual sensors can be generated to fill-in gaps in the real seismic sensors, data regularization can be applied to account for any irregularities in the real seismic sensor array, and compressive sensing can be applied to account for the sparse spacing of the real seismic sensor array. Thus, in contrast to the industry trend to increase the number of seismic sensors in an effort to improve the seismic data acquired, Applicants have developed techniques that enable the use of relatively fewer seismic sensors to generate relatively high-resolution seismic images. Such techniques can enable acquiring seismic data at a relatively low cost, while still providing relatively high-resolution seismic images using the seismic data acquired at the relatively low cost.

The resulting seismic images may be enhanced seismic images (e.g., seismic images having resolutions higher than seismic images of the same area generated using existing acquisition and processing techniques with the same or similarly configured real seismic sensor array). In some embodiments, the enhanced seismic images can be used to generate formation models (also referred to as “reservoir models”), including three-dimensional representations of the various features of the subsurface formation. These formation models can be used, for example, to identify locations of hydrocarbon reservoirs (e.g., oil and gas reservoirs) in the subsurface formation, and assess the ability of the hydrocarbon reservoirs to produce hydrocarbons (e.g., oil and gas). In some embodiments, a field development plan (FDP) can be generated based on the formation models (e.g., based on the identified locations of hydrocarbon reservoirs) and the ability of the hydrocarbon reservoirs to produce hydrocarbons. An FDP can, for example, identify locations for drilling wells to produce the hydrocarbons and even wellbore paths (also referred to as “well trajectories”) for the respective wells. Ultimately, wells (e.g., production, injection and monitoring wells) can be drilled into the formation, and be operated according to the FDP to efficiently produce hydrocarbons from the reservoirs. Thus, the disclosed seismic imaging techniques, including virtual arrays, data regularization and compressive sensing can provide a key element in discovering and developing hydrocarbon reservoirs.

Although certain embodiments are described in the context of seismic imaging of hydrocarbons reservoirs for the purpose of illustration, it will be appreciated that the embodiments described herein can be employed in any suitable context.

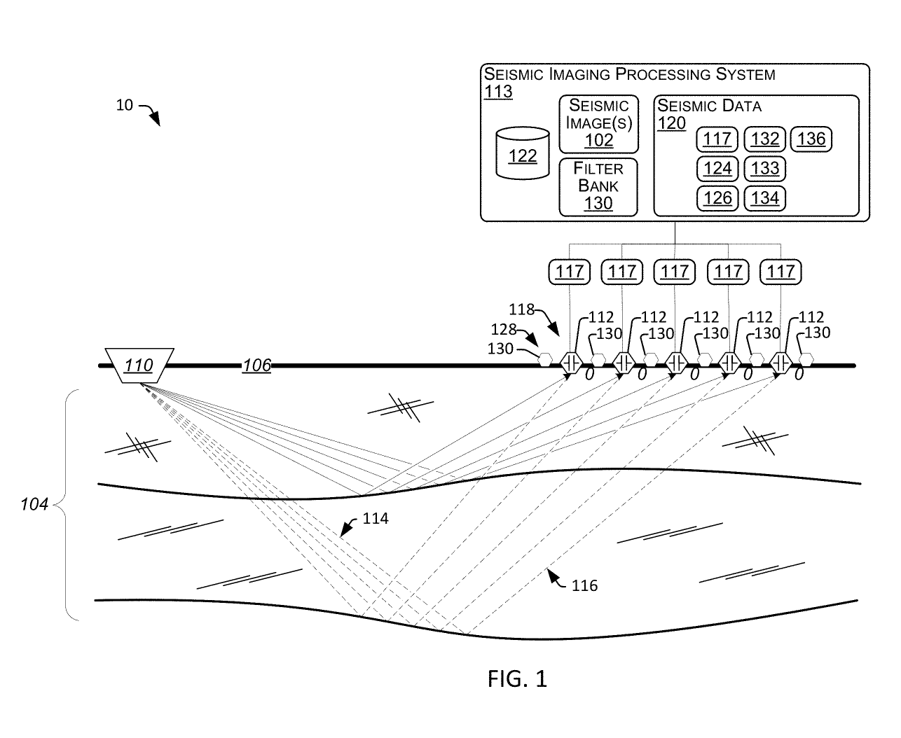

FIG. 1 is a diagram that illustrates an example seismic imaging environment (“environment”) 10 in accordance with one or more embodiments. The environment 10 can include a seismic imaging system 100 for generating seismic images 102 of a formation (a “subsurface formation”) 104, located below the Earth's surface 106. The Earth's surface 106 can include, for example, a surface of land or a surface of the ocean floor. The seismic imaging system 100 can include one or more seismic energy sources 110, real seismic sensors (also referred to as “real seismic receivers”) 112, and a seismic processing system (“processing system”) 113. During operation, the seismic energy source 110 can emit waves of seismic energy (“seismic waves”) 114 into the subsurface formation 104, and the real seismic sensors 112 can sense resulting seismic energy waves (“echoes” or “wavefields”) 116 reflected by various features of the subsurface formation 104, such as boundaries between different layers of rock. The seismic echoes 116 can include a P-wave component and a shear component (e.g., two shear (SV and SH) wave components).

In some embodiments, the seismic source 110 is configured to emit seismic waves 114 (e.g., sound waves) into the subsurface formation 104. For example, the seismic source 100 can include an explosive (e.g., dynamite) or a mechanical device (e.g., an air gun or a seismic vibrator) that generates the seismic waves 114. In some instances, at least a portion of the seismic waves 114 propagate into the subsurface formation 104 and reflect off of various features of the subsurface formation 104 (e.g., boundaries between different layers of rock), thereby generating corresponding seismic echoes 116. The seismic echoes 116 can, for example, propagate through the subsurface formation 104 to a location of one or more of the real seismic sensors 112.

In some embodiments, the real seismic sensors 112 are configured to sense seismic energy of the seismic echoes 116. For example, the real seismic sensors 112 can be configured to sense waveforms of the seismic echoes 116 generated as a result of the seismic waves 114 reflecting off of the features in the subsurface formation 104. In some embodiments, the real seismic sensors 112 are geophones or hydrophones. A geophone may be a seismic energy sensing device that generates senses ground movement (or displacement of the ground) and generates a voltage that corresponds to the ground movement. The deviation of this measured voltage from a base line is sometimes referred to as the “signal response” or “seismic response” for the receiver. A hydrophone may be a microphone designed to be used underwater for recording underwater sound. A hydrophone may employ a piezoelectric transducer that generates electricity when subjected to a pressure change, such as a pressure change resulting from the resulting seismic echoes 116 traveling through the water surrounding the hydrophone. In some embodiments, the real seismic sensors 112 include geophones disposed at the Earth's surface 106 proximate the subsurface formation 104 (e.g., on land or on the ocean floor above the subsurface formation 104), geophones disposed in boreholes drilled into the subsurface formation 104, or hydrophones suspended in a body of water above the subsurface formation 104.

In some embodiments, the real seismic sensors 112 include a given number (L) of seismic sensors physically positioned to form an array of seismic sensors (also referred to as a “seismic sensor array” or “seismic receiver array”) 118 for sensing the seismic energy of the seismic echoes 116 from the subsurface formation 104. The seismic energy source 110 and the real seismic sensor array 118 can be positioned at the Earth's surface 106 proximate the subsurface formation 104 (e.g., on land or on the ocean floor above the subsurface formation 104) for generating one or more seismic images 102 of the subsurface formation 104. The seismic sensor array 118 can include multiple real seismic sensors 112 physically distributed on the earth's surface 106 and/or suspended in a body of water above the subsurface formation 104. Although the real seismic sensor array 118 illustrated includes five real seismic sensors 112 generally spaced evenly in a uniform linear distribution for the purpose of illustration, it will be appreciated that the real seismic sensor array 118 can include any suitable number and distribution of real seismic sensors 112.

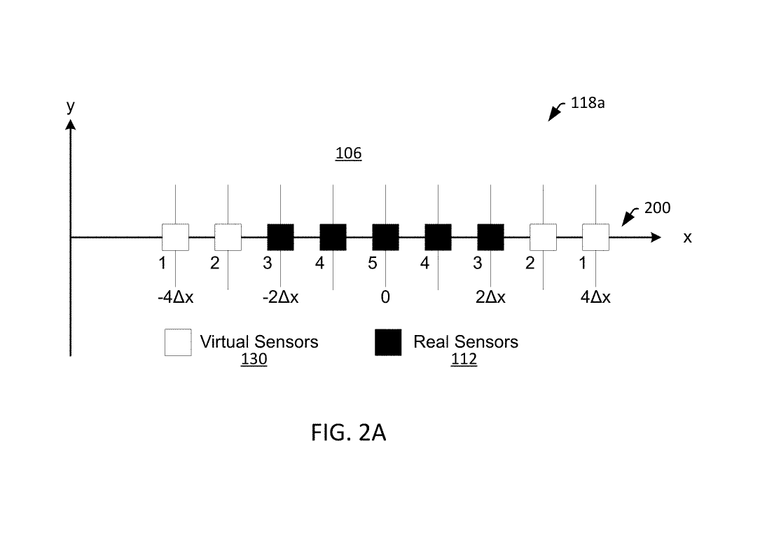

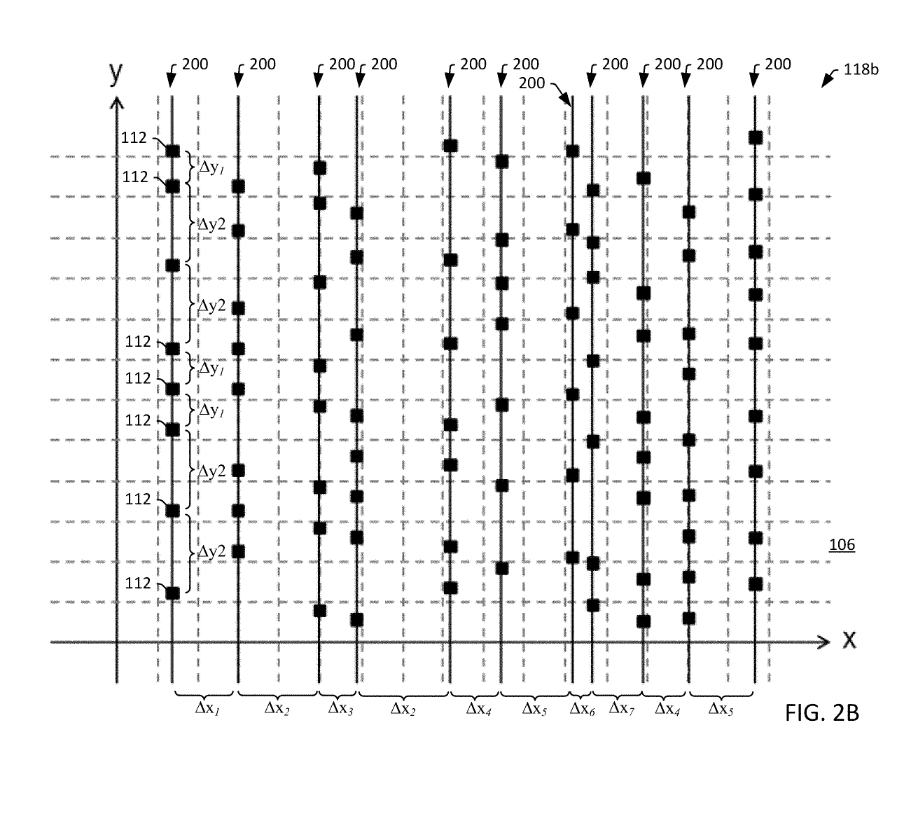

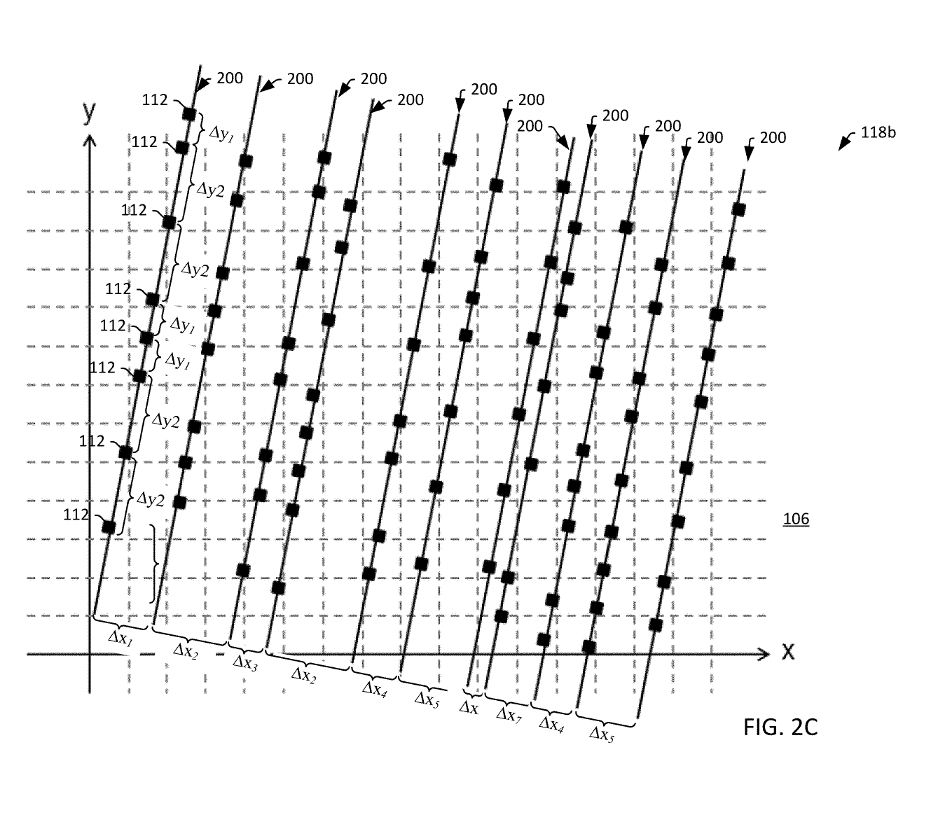

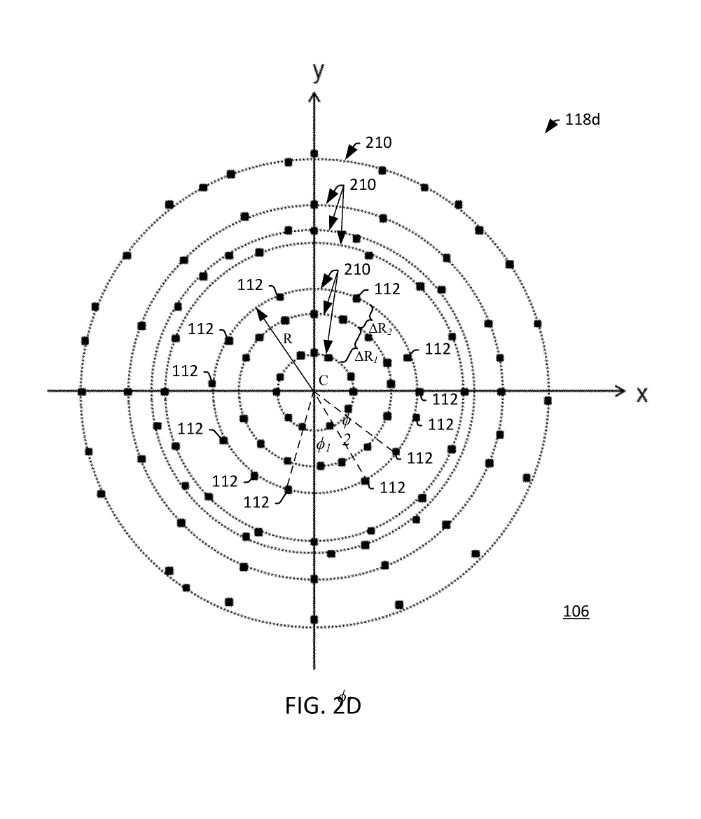

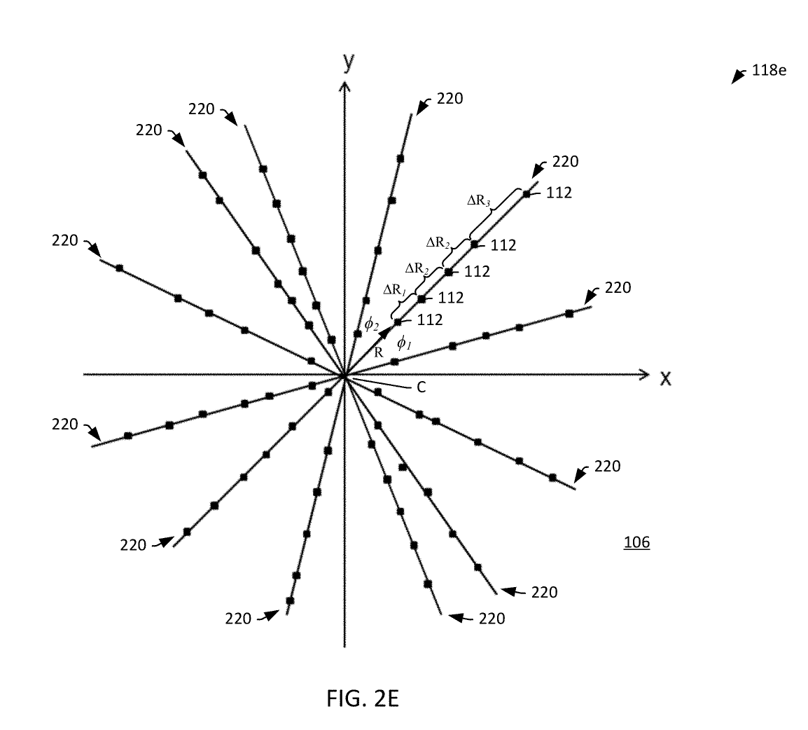

In some embodiments, the real seismic sensor array 118 can include a uniform distribution (e.g., a uniform linear or grid distribution) or non-uniform distribution (e.g., a non-uniform liner, grid, circle or star distribution) of real seismic sensors 112. For example, the real seismic sensor array 118 may have a uniform distribution (or “pattern”) of the real seismic sensors 112 the real seismic sensor array 118. Such a uniform distribution may be defined, for example, by the real seismic sensors 112 the real seismic sensor array 118 having even spacing of the real seismic sensors 112 (e.g., the same spacing between each adjacent pair of the real seismic sensors 112). In some embodiments, the real seismic sensor array 118 can be arranged in a uniform linear distribution that includes a plurality of real seismic sensors 112 evenly spaced from one another by a given distance, in a single dimension (e.g., forming a line of real seismic sensors 112 evenly spaced in the x-dimension by a given distance (Δx)). FIG. 2A is a diagram that illustrates an example uniform real seismic sensor array 118a having real seismic sensors 112 having a uniform linear distribution. The uniform real seismic sensor array 118a includes a line of real seismic sensors 200 including five real seismic sensors 112 that are evenly spaced from one another by a given distance (Δx), such that each adjacent pair of real seismic sensors 112 of the real seismic sensor array 118a are spaced the given distance (Δx) from one another. As another example, the real seismic sensor array 118 can be arranged in a uniform grid pattern that includes a plurality of real seismic sensors 112 evenly spaced from one another in two dimensions. This can include, for example, multiple lines of real seismic sensors 200 each having the same uniform linear distribution of evenly spaced real seismic sensors 112 to form a grid of real seismic sensors 112. The real seismic sensors 112 of the uniform grid distribution may be evenly spaced from one another in the x and y-dimensions by a given distance (Δxy) such that each real seismic sensor 112 of the grid distribution is surrounded by two to four real seismic sensors 112, that are each spaced from the real seismic sensor 112 in the x or y-dimension by the given distance (Δxy).

In some embodiments, the real seismic sensor array 118 is non-uniform, including a plurality of real seismic sensors 112 arranged in a non-uniform distribution. For example, the real seismic sensor array 118 can include a non-uniform linear distribution, a non-uniform orthogonal grid distribution, a non-uniform skewed grid distribution, a non-uniform circular distribution, or a non-uniform star distribution. A non-uniform linear distribution can include a line of real seismic sensors (e.g., similar to the line of real seismic sensors 200 of the real seismic sensor array 118a of FIG. 2A) 200, with the real seismic sensors 112 of the line 200 being unevenly spaced along the line 200 such that some or all of the respective pairs of adjacent real seismic sensors 112 on the line 200 have different spacings there between (e.g., Δx₁ and Δx₂).

FIGS. 2B-2E illustrate example non-uniform real seismic sensor arrays (also referred to as “sampling models of non-uniform real seismic sensor arrays”) in accordance with one or more embodiments. The illustrations of FIGS. 2B-2E may be, for example, top views of the respective distributions on the earth's surface 106, as if looking down on the earth's surface 106 and the real seismic sensor array 118 distributed thereon. For example, FIG. 2B illustrates an example non-uniform real seismic sensor array 118b having real seismic sensors 112 arranged in a non-uniform orthogonal grid distribution. For example, the real seismic sensors 112 of the real seismic sensor array 118b can be arranged in a non-uniform two-dimensional orthogonal grid distribution that includes a plurality of real seismic sensors 112 un-evenly spaced from one another. The array 118b can include multiple lines of real seismic sensors 202 that each include a non-uniform linear distribution of multiple real seismic sensors 112. For example, the real seismic sensors 112 of the each of the lines 200 may be unevenly spaced along the line 200 (e.g., in the y-dimension) such that some or all of the respective pairs of adjacent real seismic sensors 112 on the line 200 have different spacings there between (e.g., Δy₁ and Δy₂). As illustrated in FIG. 2B, the lines of real seismic sensors 200 can be oriented parallel to one another, and can be un-evenly spaced from one another (e.g., in the x-dimension) such that some or all of the respective pairs of adjacent lines of real seismic sensors 200 have different spacings there between (e.g., Δx₁-Δx₇). In some embodiments, the lines of real seismic sensors 200 can be evenly spaced from one another (e.g., in the X dimension) such all of the respective pairs of adjacent lines of real seismic sensors 200 have the same spacings there between.

FIG. 2C illustrates an example non-uniform real seismic sensor array 118c having real seismic sensors 112 disposed in a non-uniform skewed grid distribution. For example, the real seismic sensors 112 of the real seismic sensor array 118c can be arranged in a non-uniform two-dimensional skewed grid distribution that includes a plurality of real seismic sensors 112 un-evenly spaced from one another. The array 118b can include multiple lines of real seismic sensors 202 that each include a non-uniform linear distribution of multiple real seismic sensors 112. For example, the real seismic sensors 112 of the each of the lines 200 may be unevenly spaced along the line 200 (e.g., in the y-dimension) such that some or all of the respective pairs of adjacent real seismic sensors 112 on the line 200 have different spacings there between (e.g., Δy₁ and Δy₂). As illustrated in FIG. 2C, the lines of real seismic sensors 200 can be oriented parallel to one another, and be skewed at an angle (e.g., skewed at an angle (θ) from the y-axis), and can be un-evenly spaced from one another such that some or all of the respective pairs of adjacent lines of real seismic sensors 200 have different spacings there between (e.g., Δx₁-Δx₇). In some embodiments, the lines of real seismic sensors 200 can be evenly spaced from one another such all of the respective pairs of adjacent lines of real seismic sensors 200 have the same spacings there between.

FIG. 2D illustrates an example non-uniform real seismic sensor array 118d having real seismic sensors 112 arranged in a non-uniform circular distribution. The array 118d can include concentric circles (or “rings”) of real seismic sensors 210 that can each include multiple real seismic sensors 112. The real seismic sensors 112 of each circle 210 can be unevenly spaced along the circle 200 (e.g., having different azimuths (φ) there between) such that some or all of the respective pairs of adjacent real seismic sensors 112 on the circle 210 have different azimuthal spacings there between (e.g., φ₁ and φ₂). Each of the circles 210 may have a respective radius (R) from a central point (C). As illustrated in FIG. 2D, the circles of real seismic sensors 210 can be un-evenly spaced from one another (e.g., in the radial direction) such that some or all of the respective pairs of adjacent circles of real seismic sensors 210 have different radial spacings there between (e.g., ΔR₁ and ΔR₂). In some embodiments, the circles of real seismic sensors 210 can be evenly spaced from one another such that all of the respective pairs of adjacent circles of real seismic sensors 210 have the same radial spacings there between.

FIG. 2E illustrates an example non-uniform real seismic sensor array 118e having real seismic sensors 112 arranged in a non-uniform star distribution. The array 118e includes radial lines of real seismic sensors 220 that each include multiple real seismic sensors 112. The real seismic sensors 112 of each radial line 220 can be unevenly spaced along the radial line 220 such that some or all of the respective pairs of adjacent real seismic sensors 112 on the radial line 220 have different spacings there between (e.g., ΔR₁-ΔR₃). Each of the radial lines 220 may extend at a respective azimuth (φ) from a central point (C). As illustrated in FIG. 2E, The radial lines of real seismic sensors 220 can be un-evenly spaced from one another such that some or all of the respective pairs of adjacent radial lines 220 have different azimuthal spacings there between (e.g., φ₁ and φ₂). In some embodiments, the radial lines of real seismic sensors 220 can be evenly spaced from one another such that all of the respective pairs of adjacent radial lines 220 have the same azimuthal spacings there between.

In some embodiments, the real seismic sensors 112 are configured to output seismic responses (or “signal responses”) 117 corresponding to the seismic echoes 116 sensed by the real seismic sensors 112. For example, a signal response 117 generated by a given one of the real seismic sensors 112 can include time-series data that includes an indication of an arrival time of, and variations in the magnitude (or “intensity”) over time of, one or more echoes 116 sensed by the real seismic sensor 112. For example, where a given one of the real seismic sensors 112 includes a geophone, a signal response 117 generated by the real seismic sensor 112 can include a recording of voltages over a time period that correspond to ground movement caused by one or more of the seismic echoes 116.

In some embodiments, seismic data 120 corresponding to the seismic echoes 116 sensed by the real seismic sensors 112 is recorded and stored, for example, in a seismic data database 122. The seismic data 120 can include seismic field records, such as recordings of the signal responses 117 output by the real seismic sensors 112. In some embodiments, the seismic echoes 116 can include a given number (I) of statistically independent signals that are received at the real seismic sensors 112. In such an embodiment, the seismic data 120 can include signal responses 117 that are representative of each of the statistically independent signals that are received at each of the real seismic sensors 112. As described herein, the seismic data 120 can be processed (e.g., by the seismic processing system 113) to generate one or more seismic images 102 of the subsurface formation 104.

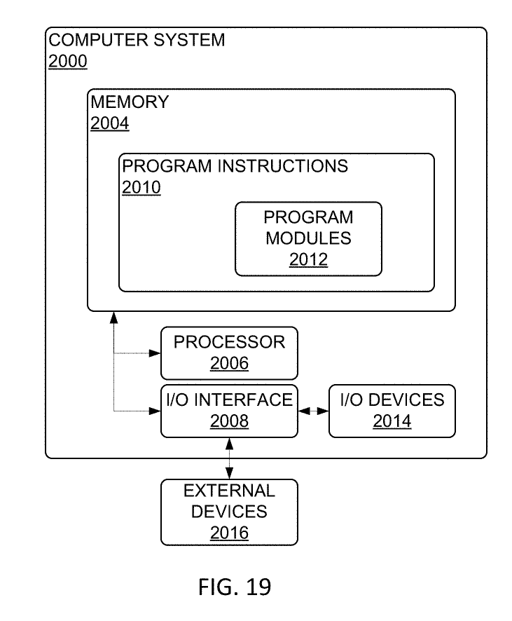

In some embodiments, the seismic processing system 113 includes a computer system that is the same or similar to computer system 2000 described herein with regard to at least FIG. 19. In some embodiments, the seismic processing system 113 includes a filterbank 130. The filterbank 130 can include an array of band-pass filters that separate an input signal into several components. For example, where a signal includes a given wide frequency band, the filterbank 130 can include an array of band-pass filters that separate the signal into separate signals of a single-frequency sub-band (or “narrowband”) of the original signal. Such a filterbank 130 can be used, for example, to divide wideband signals (e.g., wideband signal responses 117) into corresponding separate narrowband signals 124 for processing as described herein. In some embodiments, the filterbank 130 is configured such that resulting sub-bands can be recombined to recover the original signal.

In some embodiments, the seismic processing system 113 controls acquisition and/or processing of the seismic data 120. For example, the seismic processing system 113 may control operation of the seismic source 110 and/or the real seismic receivers 112 to obtain the signal responses 117, as described herein. In some embodiments, the seismic processing system 113 can employ the filter bank 130 to generate narrowband signals 124. The seismic processing system 113 may store seismic data 120 that includes the signal responses 117 and/or the narrowband signals 124, in the database 122. In some embodiments, the seismic processing system 113 processes the seismic data 120 using the techniques described herein, such as the virtual array and/or the data regularization techniques described herein. For example, the seismic processing system 113 may employ the virtual array techniques described herein to generate a virtual seismic array data 126 from the signal responses 117 generated by the real seismic sensor array 118. The virtual seismic array data 126 can include data representing a virtual seismic array 128 that includes the real seismic sensors 112 of the real seismic sensor array 118 used to acquire the signal responses 117 and/or one or more virtual seismic sensors 130 represented by the virtual seismic array data 126. As a further example, the seismic processing system 113 may employ the regularization techniques described herein to generate regularized seismic data 132. The regularization techniques described herein may be applied to the signal responses 117 and/or the virtual seismic array data 126 to generate regularized seismic data 132. In some embodiments, the seismic processing system 113 generates one enhanced seismic traces 133 and/or one or more enhanced seismic images 102 using the virtual seismic array data 126 and/or the regularized seismic data 132.

In some embodiments, the enhanced seismic images 102 can be used to generate one or more formation models (also referred to as “reservoir models”) 134, including three-dimensional representations of the various features of the subsurface formation 104. These formation models 134 can be used, for example, to identify locations of hydrocarbon reservoirs (e.g., oil and gas reservoirs) in the subsurface formation 104, and assess the ability of the hydrocarbon reservoirs to produce hydrocarbons (e.g., oil and gas). In some embodiments, a field development plan (FDP) 136 can be generated based on the formation models 134 (e.g., based on the identified locations of hydrocarbon reservoirs) and the ability of the hydrocarbon reservoirs to produce hydrocarbons. An FDP 136 can, for example, identify locations for drilling wells to produce the hydrocarbons and even wellbore paths (also referred to as “well trajectories”) for the respective wells. Ultimately, wells (e.g., production, injection and monitoring wells) can be drilled into the formation 104, and be operated according to the FDP 136 to efficiently produce hydrocarbons from the reservoirs.

Virtual Seismic Sensor Array

In some embodiments, virtual seismic sensors (e.g., virtual seismic sensors 130) can be generated from real (or “actual”) seismic sensors (e.g., real seismic sensors 112). This can be accomplished based on a recognition that seismic data acquired from the real seismic sensors is generally non-Gaussian. Such virtual seismic sensors can be used, for example, to fill in gaps in real seismic sensor arrays and/or to provide a dense virtual seismic sensor array (e.g., virtual seismic sensor array 128) that can help to eliminate aliasing artifacts. Although seismic data is generally wideband, certain derivations described herein focus on narrowband signals. It will be appreciated that wideband signals can be divided into several narrowband signals by using a filterbank (e.g., filterbank 130). The following provides a discussion of how virtual seismic sensors and arrays can be generated based on seismic data (e.g., seismic data 120) acquired via real seismic sensor arrays (e.g., real seismic sensor array 118).

In some embodiments, an array response for a real seismic sensor array (e.g., including a signal response for each of the real seismic sensors 112 of the real seismic sensor array 118) can be generated based on characteristics of the signals (e.g., seismic echoes 116) received at the real sensors of the real seismic sensor array. For example, if there are I statistically independent signals (e.g., I statistically independent seismic echoes 116) impinging on an array of L sensors (also known as “elements”) (e.g., L real seismic sensors 112 of a real seismic sensor array 118), then the array response of the array (e.g., the array response of seismic sensor array 118) can be expressed as follows:

$${D}_{l} ( t ) = {\sum }_{k = 1}^{I} {S}_{k} ( t - {τ}_{lk} ) , \qquad ( 1 )$$

where Dₗ(t) is the signal output of the l-th sensor of the array, Sₖ(t) is the k-th signal response (e.g., k-th signal response 117), and τₗₖ is the propagation delay between some reference (e.g., the first sensor of the array) and the l-th sensor for a source k (e.g., seismic energy source 110). Note that the index k can be used instead of index i here to identify signal responses, and to avoid any confusion about the complex number i, which can be used in later computations. An objective can be to obtain a linear model between the array response and the impinging signals in which a mixing-matrix (described herein) is independent of time.

In some embodiments, a complex envelope for the array response (e.g., a complex envelope for each of the real seismic sensor 112 of the real seismic sensor array 118) can be generated. For example, equation (1) can be modified to be expressed in terms of the complex envelope of Dₗ(t) and Sₖ(t−τₗₖ). Where \tilde{D}ₗ(t) and \tilde{S}ₖ(t−τₗₖ) are the complex envelopes of Dₗ(t) and Sₖ(t−τₗₖ), respectively, then equation (1) can be expressed as follows:

$${\tilde{D}}_{t} ( t ) = {\sum }_{k = 1}^{l} {\tilde{S}}_{k} ( t - {τ}_{lk} ) . \qquad ( 2 )$$

Accordingly, each signal response Sₖ(t) may correspond to a statistically independent signal (k) (e.g., an echo 116) sensed at a real seismic sensor (l) of the real seismic sensor array (e.g., a real seismic sensor 112 of the seismic sensor array 118).

In some embodiments, each of the complex envelopes for the array response (e.g., the complex envelope for each of the real seismic sensors 112 of the real seismic sensor array 118) are decomposed into one or more narrow band signals. These narrowband signal(s) for a given real seismic sensor of the real seismic sensor array correspond to the signal response (e.g., signal response 117) for the real seismic sensor 112. For example, assuming that Sₖ(t) are narrow-band signals, it can be said that \tilde{S}ₖ(t−τₗₖ) is a phase shift of \tilde{S}ₖ(t), to determine the following:

$${\tilde{D}}_{l} ( t ) = {\sum }_{k = 1}^{I} exp [ i {ω}_{c} {τ}_{lk} ] {\tilde{S}}_{k} ( t ) , \qquad ( 3 )$$

where \tilde{S}ₖ(t) is the complex envelope of Sₖ(t) and ω_{c} is its central angular frequency. Having developed an expression for which mixing coefficients are time-independent, equation (3) can be expressed in the standard form of linear mixtures, as follows:

$$\begin{matrix}{\tilde{D}}_{l} ( t ) = {\sum }_{k = 1}^{I} {a}_{kl} {\tilde{S}}_{k} ( t ) , & ( 4 ) \\ with & \\ {a}_{kl} = exp [ i {ω}_{c} {τ}_{lk} ] . & ( 5 )\end{matrix}$$

Given that the results in equations (4) and (5) can be valid for only narrowband signals, then for wideband signals, a filterbank (e.g., filterbank 130) can be used to, first, decompose Dₗ(t) into narrowband signals, with each narrowband signal having its own central frequency.

In some embodiments, fourth-order crosscumulants are calculated for each of the narrowband signals for each of the plurality of (I) statistically independent seismic signals to define a plurality of fourth-order crosscumulants. For example, by rewriting the time delay τₗₖ in terms of the direction of the arrival time θₖ [e.g., τₗₖ=(l−1)θₖ], equation (3) can be expressed as follows:

\tilde{D}(t)=A\tilde{S}(t) (6)

A=[a(θ₁), a(θ₂), . . . , a(θ_{I})], (7)

where

a(θ)=[1, exp {−iθ)}, . . . , exp {−i(L−1)θ}]^{T} (8)

and where \tilde{D}(t) describes an L-dimension vector of the array responses, \tilde{S}(t) represents an I-dimension vector of the single-shot responses, and A represents a mixing-matrix with size L×I.

In some embodiments, a virtual steering vector for each of the plurality of (I) statistically independent seismic signals is calculated responsive to the fourth-order crosscumulants for the plurality of narrowband signals to define a plurality of virtual steering vectors. Each of the virtual steering vectors can be used as a true steering vector for a virtual seismic sensor array (e.g., virtual seismic sensor array 128) having a total of (L²) seismic sensors, with L of them being real seismic sensors (e.g., real seismic sensors 112) and the others (L²-L) being virtual seismic sensors (e.g., virtual seismic sensors 130). Turning to an analysis of the covariance and quadrcovariance of \tilde{D}(t) and \tilde{S}(t), such analysis can enable the derivation of such virtual seismic sensors and virtual seismic sensor array. For a linear relationship like the one in equation (6), the relation between the covariance of \tilde{D}(t) and the covariance of \tilde{S}(t) can be expressed as follows:

$$\underbrace{{C}_{D}^{( 2 )}}_{L \times L} = \underbrace{A}_{L \times I} \underbrace{{C}_{S}^{( 2 )}}_{I \times I} \underbrace{{A}^{H}}_{I \times L} , \qquad ( 9 )$$

or more explicitly as follows:

$${C}_{D}^{( 2 )} = {\sum }_{k}^{I} {C}_{S}^{( 2 )} ( k , k ) a ( {θ}_{k} ) {a}^{H} ( {θ}_{k} ) , \qquad ( 10 )$$

where C_{D}⁽²⁾ and C_{S}⁽²⁾ are the covariance matricies of D and S, respectively, and (.)^{H} denotes the complex conjugate transpose (e.g., the Hermitian transpose). Notably, C_{D}⁽²⁾ is an L×L matrix, whereas C_{S}⁽²⁾ is an I×I matrix. The matrices of fourth-order cumulants (also called quadricovariances) of \tilde{D}(t) and \tilde{S}(t) are related as follows:

$$\underbrace{{C}_{D}^{( 4 )}}_{{L}^{2} \times {L}^{2}} = \underbrace{[ A ⊗ \overline{A} ]}_{{L}^{2} \times {I}^{2}} \underbrace{{C}_{S}^{( 4 )}}_{{I}^{2} \times {I}^{2}} \underbrace{{[ A ⊗ \overline{A} ]}^{H}}_{{I}^{2} \times {L}^{2}} , \qquad ( 11 )$$

or more explicitly as follows:

$${C}_{D}^{( 4 )} = {\sum }_{k}^{I} {C}_{S}^{( 4 )} ( k , k , k , k ) [ a ( {θ}_{k} ) ⊗ \overline{a} ( {θ}_{k} ) ] \cdot {[ a ( {θ}_{k} ) ⊗ \overline{a} ( {θ}_{k} ) ]}^{H} , \qquad ( 12 )$$

where [symbol] is the Kronecker product. Assuming that there is no noise, the L×L matrix C_{D}⁽²⁾ and the L²×L² matrix C_{D}⁽⁴⁾ have the same algebraic structure. The autocumulant C_{S}⁽⁴⁾(k,k,k,k) and the vector [a(θₖ) [symbol] ā(θₖ)] play in C_{D}⁽⁴⁾, the roles that C_{S}⁽²⁾(k,k) and a(θₖ), respectively, play in C_{D}⁽²⁾. Thus the L²-vector [a(θₖ) [symbol] ā(θₖ)] can be considered to be the equivalent of a virtual steering vector of the k-th signal. Thus, there is actually a total of L² seismic sensors, with L of them being real seismic sensors (e.g., real seismic sensors 112) and the others (L²-L) being virtual seismic sensors (e.g., virtual seismic sensors 130). Notably, the third-order cumulants can be ignored, for example, where the real seismic sensors (e.g., real seismic sensors 112) of the real seismic sensor array (e.g., real seismic sensor array 118) are arranged in a circular distribution (e.g., in a circular distribution that is the same or similar to that of the real seismic sensor array 118c of FIG. 2D). Further, it can be assumed that all the odd orders of cumulants are negligible.

The term “quadricovariance” is used to describe the matrix of fourth-order cumulants to emphasize the strong mathematical analogy between the quadricovariance and the usual covariance. This analogy allows introduction of the notion of a virtual seismic sensor array. In more general terms, it indicates one way the second-order-based methods can be directly extended to include fourth-order statistics. In theory, cumulants of orders higher than four in this description of virtual arrays can be considered if these cumulants are nonzero. For example, the matrix of sixth-order crosscumulants (also referred to as “hexacovariance”) of \tilde{D}(t) and \tilde{S}(t) can be expressed as follows:

$$\underbrace{{C}_{D}^{( 6 )}}_{{L}^{3} \times {L}^{3}} = \underbrace{[ A ⊗ A ⊗ \overline{A} ]}_{{L}^{3} \times {I}^{3}} \underbrace{{C}_{S}^{( 6 )}}_{{I}^{3} \times {I}^{3}} \underbrace{{[ A ⊗ A ⊗ \overline{A} ]}^{H}}_{{I}^{3} \times {L}^{3}} . \qquad ( 13 )$$

Such a virtual seismic sensors array will have L³ sensors.

The array response can be expressed as complex numbers, and be decomposed into narrow-bands, a virtual array can be generated through computing of fourth-order cross-cumulants for each narrow-band, and the virtual array responses of the narrow-band signals can be regrouped into wideband signals to generate seismic traces. Notably an greater (or “enhanced”) number of seismic traces can be generated based on there being a greater total number of seismic sensors. This can include seismic traces corresponding to the virtual and real seismic sensors of the virtual seismic sensor array, as opposed to only the real seismic sensors of the real seismic sensor array. The enhanced number of seismic traces can be used to generate enhanced seismic images.

Example Virtual Seismic Sensor Array for Linear Real Seismic Sensor Array

Looking at an example of virtual arrays associated with the quadricovariance, a uniform linear array of identical real seismic sensors (e.g., including multiple real seismic sensors 112 physically arranged in a linear distribution, such the real seismic senor array 118a of FIG. 2A including five real seismic sensors 112 physically arranged in a linear distribution) can be considered. The component l of the vector a(θₖ), noted aₗ(θₖ), can be written as follows:

$${a}_{l} ( {θ}_{k} ) = exp \{ i \frac{2 π}{λ} {x}_{l} cos ( {θ}_{k} ) \} , \qquad ( 14 )$$

with λ=f_{c}/V, where f_{c} is the central frequency of the narrow-band spectrum, V is the velocity of the medium in which the real seismic sensors are located, xₗ=(l−1)Δx is the coordinate of the real seismic sensor l of the linear array, and Δx is the spacing between sensors. The corresponding steering vector of the virtual seismic sensor array can be determined as follows:

$$\begin{matrix}{[ a ( {θ}_{k} ) ⊗ \overline{a} ( {θ}_{k} ) ]}_{p , q} = exp \{ i \frac{2 π}{λ} [ ( {x}_{p} - {x}_{q} ) cos ( {θ}_{k} ) ] \} \\ = exp \{ i \frac{2 π}{λ} [ {x}_{pq}^{′} cos ( {θ}_{k} ) ] \} ,\end{matrix} \qquad ( 15 )$$

with X_{pq}^{t}=(xₚ−x_{q})=(p−q)Δx and 1≦p, q≦L. This result shows that the virtual seismic sensor array is also a uniformly spaced linear array. Note that the L pairs (p,q), with p=q and 1≦p≦L give the same virtual-sensor position, x=0 is weighted in amplitude by factor L. Similarly, the (L−1) pairs (p,q), with q=p+1 and 1≦p≦L, give the same virtual sensor position, x=Δx. Then the virtual sensor at x=Δx is weighted in amplitude by factor (L−1), so on. The generic virtual sensor at X_{pq}^{t} is weighted in amplitude by factor (L−|p−q|). In other words, the virtual array is a weighted, uniformly spaced linear seismic sensor array with (2L−1) real and virtual seismic sensors.

Such a virtual seismic sensors array can be illustrated with reference to FIG. 2A, which illustrates a uniformly spaced virtual seismic sensor array 128a including five real seismic sensors (L=5) and four virtual seismic sensors. For a virtual seismic sensor array generated from a uniformly spaced linear real seismic sensor array of five real seismic sensors (such as that virtual seismic sensor array 128a), the virtual seismic sensor array can be weighted, although the original real seismic sensor array may not be. By way of example, the seismic sensor of the virtual array at the coordinate x_{pq} has a multiplicity of order L−|p−q|, and such is equivalent to a seismic sensor that is weighted in amplitude by a factor L−|p−q|.

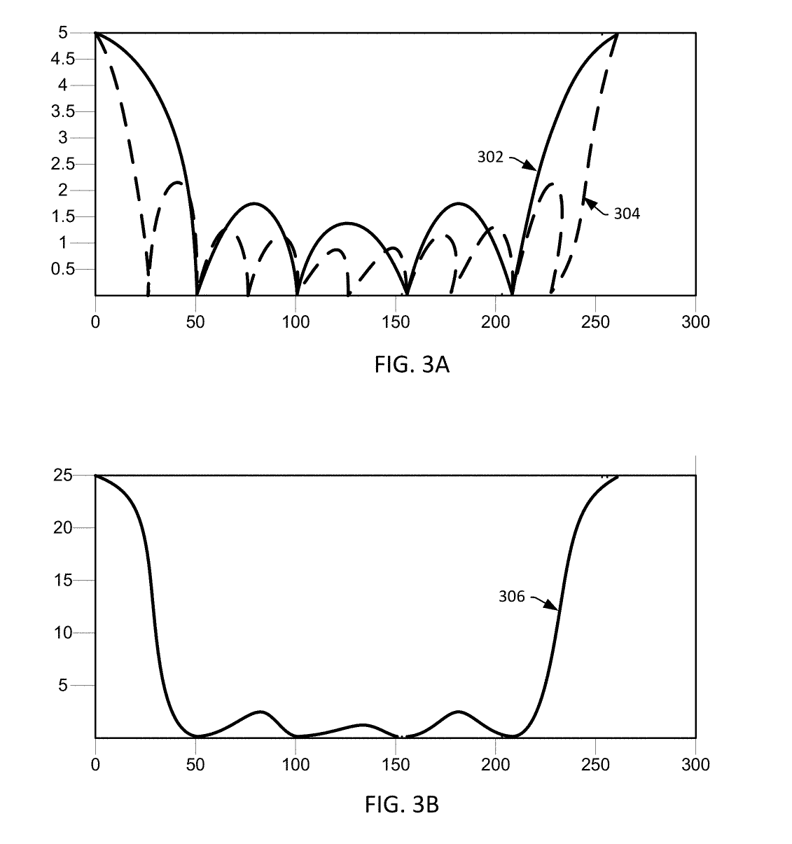

Example responses of a uniformly spaced linear array of five real seismic sensors, without virtual sensors added, is illustrated by the solid line 302 in FIG. 3A. Example responses of a uniformly spaced linear array of ten real seismic sensors (double the number of real seismic sensors for the solid line 302) without virtual sensors added is shown with reference to the dashed line 304. As is evident, increasing the number of real seismic sensors increases the attenuation overall and sharpens the resolution of the response.

The array response (or “seismic trace”) 306 produced from a virtual array (e.g., the virtual array 128a of FIG. 2A) is an amplitude-tapered, uniformly spaced linear array of 2L−1 total seismic sensors, as illustrated in FIG. 3B. Comparing FIG. 3B and FIG. 3A, the presence of amplitude tapering illustrates why the bandwidth of the virtual seismic sensor array is not twice as narrow as that of the real seismic sensor array, despite the fact that the total number of seismic sensors (of the virtual physical size) of the virtual seismic sensor array is approximately two times greater than that of the real seismic sensor array. Accordingly, the solid lines in FIGS. 3A and 3B illustrate that the enhanced resolution of the virtual seismic sensor array response has a resolution that is relatively enhanced (e.g., of a higher resolution) than that of the corresponding real seismic sensor array having five uniformly spaced real seismic sensors (e.g., of equal weights). Accordingly, the generation of virtual seismic sensors and virtual seismic sensor arrays can reduce the number of real seismic sensors needed to generate a seismic images of a given resolution, or can generate relatively high-resolution seismic images (also referred to as “enhanced seismic images”) using a given number of real seismic sensors as compared relatively low-resolution seismic images that may be generated by processing the response of the given number of real seismic sensors using existing seismic imaging techniques. As described herein, such virtual seismic sensors can be applied to uniform real seismic sensor arrays, and in some embodiments, can be applied in the context of non-uniform real seismic sensor arrays, for example, to fill in gaps in the non-uniform real seismic sensor arrays.

Regularizing Non-Uniformly Sampled Seismic Data

As discussed, although it may be desirable to physically positon real seismic sensor arrays in a uniform (or “regular”) distribution to, for example, suit certain existing processing techniques, physical placement of real seismic sensors in a uniform distribution may not be feasible due to physical constraints that inhibit the physical positioning of real seismic sensors in certain locations. In some embodiments, data regularization techniques can be applied to “regularize” the “irregular” seismic data acquired using non-uniform (or “irregular”) real seismic sensor arrays, such as real seismic sensor arrays (e.g., real seismic sensor arrays 118) that have gaps and/or relatively large spacings between the real seismic sensors of the array.

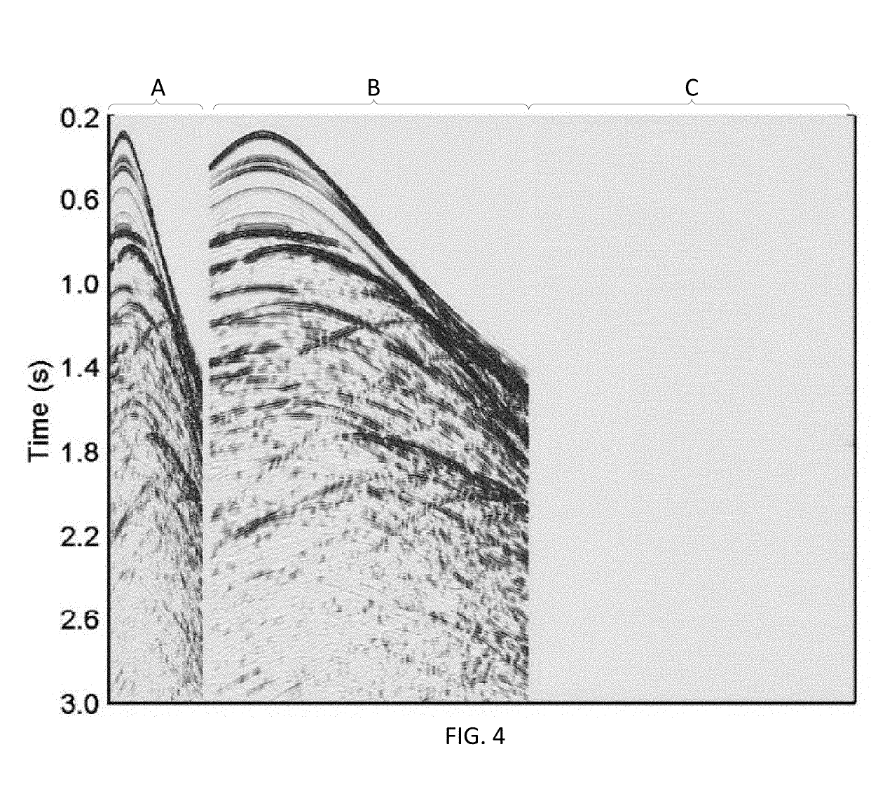

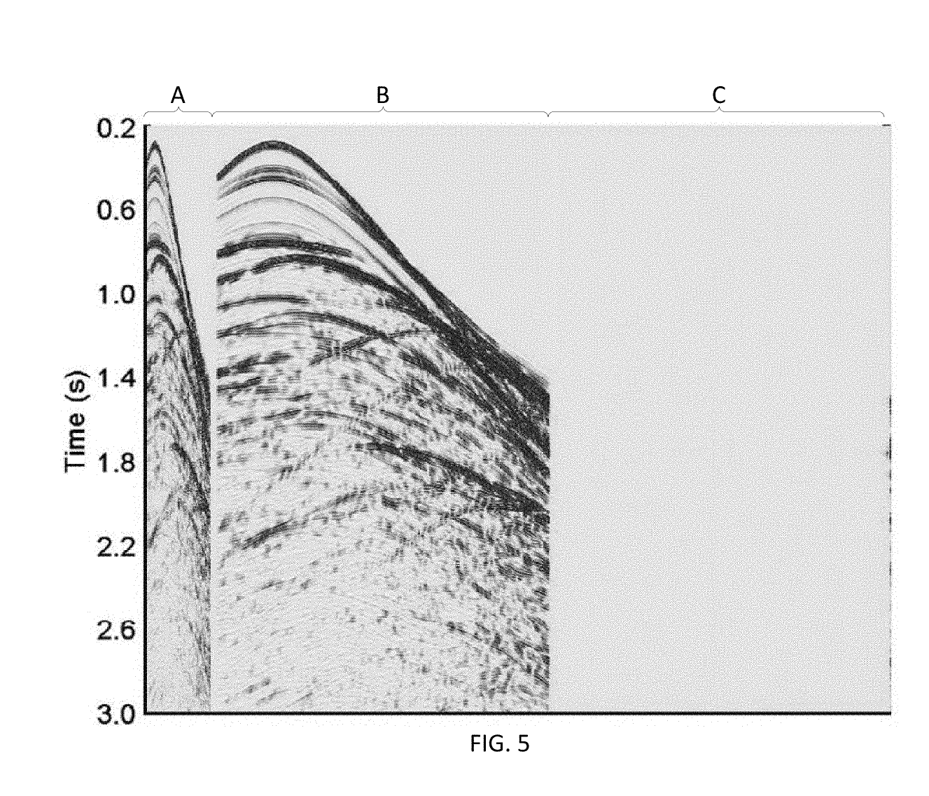

The following provides brief discussions of figures that illustrate the execution and advantages of certain regularization techniques, and that are referenced throughout this discussion. FIGS. 4 and 5 illustrate shot gathers of a non-uniform real seismic sensor array (or “distribution”) in accordance with one or more embodiments. FIG. 4 illustrates shot gathers of a non-uniform real seismic sensor array in accordance with one or more embodiments. Portion A of FIG. 4 illustrates a shot gather of a real seismic sensor array, with real seismic sensor locations defined as xₙ=nΔx+εₙ, with Δx=10 m and Δₙ ∈ [−2 m, 2 m], and where the pressure and the gradient of the pressure were recorded. Portion B of FIG. 4 illustrates a reconstructed shot gather for a uniform real seismic sensor array, with Δx=6 m, generated using the interpolation function of equation (22) discussed below. Portion C of FIG. 4 illustrates differences between reconstructed data in portion B of FIG. 5 and the actual data recorded by real seismic sensors at the same locations of the interpolated data.

FIG. 5 illustrates shot gathers of a non-uniform real seismic sensor array in accordance with one or more embodiments. Portion A of FIG. 5 illustrates a shot gather of a non-uniform real seismic sensor array, with real seismic sensor locations defined as xₙ=nΔx+εₙ, with Δx=10 m and εₙ ∈ [−2 m, 2 m], and where the pressure and first and second derivatives of the pressure with respect to x were recorded. Portion B of FIG. 5 illustrates a reconstructed shot gather for a uniform real seismic sensor array, with Δx=6 m, using the interpolation function in equation (24), discussed below. Portion C of FIG. 5 shows differences between the reconstructed data in portion B of FIG. 5 and the actual data recorded by real seismic sensors at the same locations of the interpolated data.

Data Regularization—Lagrange Interpolation Involving Derivatives

An objective of non-uniform wavefield sampling can be to reconstruct data from real seismic sensor arrays (or “distributions”) with gaps between real seismic sensors of the array. These gaps can include, for example, gaps due to obstacles, like buildings, that prevent the placement of real seismic sensors in certain areas for sensing echoes in seismic surveys. An alternative data reconstruction solution, which involves multiple-component wavefield recordings, is provided to overcome these and other potential issues. Some of these components are different orders of derivatives of the same quantities. In some embodiments, multiple-component recordings can be employed to collect data with a wider spacing interval between real seismic sensors in the context of uniform sampling (e.g., acquiring seismic data 120 using a uniform real seismic sensor array 118) or with some large gaps between some real seismic sensors in the context of non-uniform sampling (e.g., acquiring seismic data 120 using a non-uniform real seismic sensor array 118). If Δx is the average spacing interval between real seismic sensors required by the Nyquist criterion of a given physical quantity, and (R−1) is the number of components recorded in addition to the quantity under consideration, this average spacing can increase to Δx_{R}−RΔx for uniform sampling if the first (R−1) orders of derivatives of this quantity with respect to x in addition to the quantity under consideration is recorded. Thus, if the particle velocity is recorded, with its first nine orders of derivatives with respect to x, a gap of more than 100 m can be included between real seismic sensors. Unfortunately, the sensitivity of real seismic sensors (e.g., real seismic sensors 112) may be such that only the first two derivatives of the wavefield can be recorded. The concept of a virtual seismic sensor array (described herein) may, thus, be employed to generate virtual seismic sensors that can be combined with the real seismic sensors to generate a virtual seismic sensor array that can accommodate large gaps (e.g., larger gaps for the embodiments of the method proposed herein). The virtual seismic sensor array can include a given number of seismic sensors, including the real seismic sensors and the virtual seismic sensors generated using the techniques described herein. In some embodiments, the seismic sensors the virtual seismic sensor array (e.g. including the real seismic sensors and the virtual seismic sensors) can be used as the seismic sensors that form the basis of the regularization techniques described herein.

An average real seismic sensor interval (or the effective real seismic sensor interval) can be defined as follows:

$$Δ {x}_{R} = \frac{1}{N} {\sum }_{n = 0}^{N - 1} {x}_{n} \qquad ( 16 )$$

for a distribution of a number (N) of real seismic sensors (e.g., N real seismic sensors 112). As long as the absolute values of all the wavenumbers contained in the continuous wavefield p(x,t) are smaller than 1/(2Δx_{R}) and the real seismic sensor positions xₙ do not deviate by more than Δx_{R}/(4R) from a uniform grid with a spacing of Δx_{R}, then the continuous wavefield p(x, t) may be uniquely reconstruct from its non-uniform samples p(xₙ,t) and its (R−1) derivatives, as follows:

$$\begin{matrix}p ( x , t ) = {\sum }_{n = 0}^{N - 1} p ( {x}_{n} , t ) {h}_{n}^{( 0 )} ( x ) + {ζ}^{( 1 )} ( {x}_{n} , t ) {h}_{n}^{( 1 )} ( x ) + … + {ζ}^{( R - 1 )} ( {x}_{n} , t ) {h}_{n}^{( R - 1 )} ( x ) , & ( 17 ) \\ { {ζ}^{( j )} ( {x}_{n} , t ) = \frac{1}{j !} \frac{{\partial }^{j}}{\partial {x}^{j}} [ \frac{p ( x , t )}{{h}_{n} ( x )} ] \vert}_{x = {x}_{n}} , 0 \leq j \leq R - 1 , & ( 18 ) \\ {h}_{n}^{( l )} ( x ) = {\{ [ {\prod }_{q = 0 , q \neq n}^{N - 1} \frac{1}{sin [ π ( {x}_{n} - {x}_{q} ) / X ]} ] {\prod }_{m = 0}^{N - 1} sin [ π ( x - {x}_{m} ) / X ] \}}^{R} \times \frac{1}{π} {\sum }_{k = - ∞}^{∞} \frac{{( - 1 )}^{kNR}}{{\{ [ ( x - {x}_{n} ) / X ] - k \}}^{R - t}} , & ( 19 )\end{matrix}$$

where p⁽ⁱ⁾(xₙ,t) is the i-th derivative of the continuous wavefield p(x,t) with respect to x at x=xₙ. Two cases can again be distinguished: (i) both R and N take odd values, and (ii) R and/or N are even. Supposing that R and N are both odd, the following can be determined:

$${h}_{n}^{( l )} ( x ) = {\{ {\prod }_{m = 0 , m \neq n}^{N - 1} \frac{sin [ π ( x - {x}_{m} ) / X ]}{sin [ π ( {x}_{n} - {x}_{m} ) / X ]} \}}^{R} {( x - {x}_{n} )}^{l} , \qquad ( 20 )$$

when N and R are odd, and

$${h}_{n}^{( l )} ( x ) = {\{ cos [ \frac{π ( x - {x}_{n} )}{X} ] {\prod }_{m = 0 , m \neq n}^{N - 1} \frac{sin [ π ( x - {x}_{m} ) / X ]}{sin [ π ( {x}_{n} - {x}_{m} ) / X ]} \}}^{R} {( x - {x}_{n} )}^{l} , \qquad ( 21 )$$

when N and/or R are even.

For R=2, the interpolation formula in (2) can be reduced to the following:

$$\begin{matrix}p ( x , t ) = {\sum }_{n = 0}^{N - 1} [ p ( {x}_{n} , t ) + ( x - {x}_{n} ) {p}^{( 1 )} ( {x}_{n} , t ) ] {h}_{n} ( x ) , & ( 22 ) \\ with & \\ {h}_{n} ( x ) = {\{ cos [ \frac{π ( x - {x}_{n} )}{X} ] {\prod }_{m = 0 , m \neq n}^{N - 1} \frac{sin [ π ( x - {x}_{m} ) / X ]}{sin [ π ( {x}_{n} - {x}_{m} ) / X ]} \}}^{2} . & ( 23 )\end{matrix}$$

For R=3 and with an even N, the interpolation formula in (2) can be reduced to the following:

$$\begin{matrix}p ( x , t ) = {\sum }_{n = 0}^{N - 1} [ p ( {x}_{n} , t ) + ( x + {x}_{n} ) {p}^{( 1 )} ( {x}_{n} , t ) + {( x - {x}_{n} )}^{2} {Ϛ}^{( 2 )} ( {x}_{n} , t ) ] {h}_{n} ( x ) , & ( 24 ) \\ with & \\ {Ϛ}^{( 2 )} ( {x}_{n} , t ) = \frac{1}{2} [ {p}^{( 2 )} ( {x}_{n} , t ) + {k}_{1} ( {x}_{n} ) p ( {x}_{n} , t ) ] , & ( 25 ) \\ {h}_{n} ( x ) = {\{ cos [ \frac{π ( x - {x}_{n} )}{X} ] {\prod }_{m = 0 , m \neq n}^{N - 1} \frac{sin [ π ( x - {x}_{m} ) / X ]}{sin [ π ( {x}_{n} - {x}_{m} ) / X ]} \}}^{3} , & ( 26 ) \\ {k}_{1} ( {x}_{n} ) = {2 [ \frac{{\partial }^{2} {h}_{n} ( x )}{\partial {x}^{2}} ]}_{x = {x}_{n}} . & ( 27 )\end{matrix}$$

A numerical illustration of the data reconstruction using the formulas (22) and (24) can be considered. Starting with the formula in (22) and considering a non-uniformly sampled shot gather (e.g., as depicted and discussed with regard to portion A of FIG. 4, real seismic sensor locations may be expressed as the following:

xₙ=nΔx₂+εₙ, (28)

with Δx₂=20 m, and Eₙ is extracted from a uniform distribution in the interval [−8 m, 8 m]. Portion B of FIG. 4 illustrates a reconstructed uniform data at xₙ=nΔx, with Δx=6 m when using the formula in (22). The differences between the reconstructed data and the actual computed uniform data in portion B of FIG. 4 illustrates that the data reconstruction with the first derivative of the wavefield, in addition to the wavefield itself, is quite effective, even for non-uniformly sampled data. This can be repeated in accordance with the following:

xₙ=nΔx_{S}+εₙ, (29)

where Δx3=30 m and where Eₙ is extracted from a uniform distribution in the interval [−10 m, 10 m]. The corresponding uniformly sampled shot gather is shown in portion A of FIG. 5, with N=100 now. Portion B of FIG. 5 illustrates the reconstructed uniform data at xₙ=nΔx, with Δx=6 m, using the formula in (29). Again, it can be seen that the difference between the reconstructed data and the actual computed uniform data in portion C of FIG. 5 are negligible.

Lagrange Interpolation for Parallel Lines of Sources and Seismic Sensors

A 2D line of a seismic survey can be described as p(xₛ,xᵣ,t), where xₛ represents the locations of the shot points (or “seismic sources”) and xᵣ represents the locations of the seismic sensors. If xₛ is fixed, then the above formulas can be used to reconstruct the continuous wavefield from its response to a non-uniform seismic sensor distribution (or “non-uniform seismic sensor array”), as long as this distribution, on average, satisfies the Nyquist sampling interval. Similarly, if xᵣ is fixed, then the above formulas can be used to reconstruct the continuous wavefield from its response to a non-uniform distribution of shot points, as long as this distribution, on average, satisfies the Nyquist sampling interval. A question can be asked as to whether these formulas can be generalized to 2D signals to enable direct reconstruction of the continuous wavefield p(xₛ,xᵣ,t) along xₛ and xᵣ from its response to a non-uniform distribution of shot points and seismic sensors. The answer may be, partially, yes because the distribution may be required to be in parallel lines. This requirement can be a significant limitation on the 2D signals that can be reconstructed from their non-uniform samples. Before further developing this answer, it should be noted that the 2D formulation of the Lagrange interpolation is also applicable to 3D seismic data.

The 3D seismic wavefield can be described as p(xₛ,yₛ,xᵣ,yᵣ,t), where (xₛ,yₛ) represents the locations of the shot points and (xᵣ,yᵣ) represents the locations of the seismic sensors. Thus, for a fixed shot point, (xₛ,yₛ), a signal may have two spatial variables, like a 2D line. Therefore the Lagrange interpolation of 2D signals can be used to reconstruct the continuous wavefield from its response to a 2D non-uniform seismic sensor distribution, as long as this distribution satisfies the Nyquist criterion. Similarly, for a fixed seismic sensor (xᵣ,yᵣ), the Lagrange interpolation of 2D signals can be used to reconstruct the continuous wavefield from its response to a 2D non-uniform seismic sensor distribution, as long as this distribution satisfies the Nyquist criterion.

Returning to the formulation of the Lagrange interpolation of 2D signals, let {xₙ} be a sampling sequence in which each number corresponds to a line parallel to the y-axis passing through xₙ. Let {yₙₘ} be a sequence of real numbers which defining sampling points on the line passing through xₙ (e.g., a line 200 of FIG. 2B). These sequences can represent a 2D line, a 3D shot gather, a 3D seismic sensor gather, a 3D CMP gather, or a 3D offset gather. Suppose that sequences {xₙ} and {yₙₘ} satisfy the following:

$$\begin{matrix}\vert {x}_{n} - nΔ x \vert < \frac{Δ x}{4} , & ( 30 ) \\ \vert {y}_{nm} - mΔ y \vert < \frac{Δ y}{4} , & ( 31 )\end{matrix}$$

where Δx and Δy are spatial intervals. For the case in which the first derivatives of v with respect to x and y and the second-order derivative of v with respect to x and y are recorded, along with v itself, the 2D interpolation of v can be obtained as follows:

$$υ ( x , y , t ) = {\sum }_{n = 0}^{{N}_{x} - 1} {\sum }_{m = 0}^{{N}_{y} - 1} [ υ ( {x}_{n} , {y}_{nm} , t ) + ( y - {y}_{nm} ) {υ}^{( 0 , 1 )} ( {x}_{n} , {y}_{nm} , t ) + ( x - {x}_{n} ) {υ}^{( 1 , 0 )} ( {x}_{n} , {y}_{nm} , t ) + ( x - {x}_{n} ) ( y - {y}_{nm} ) {υ}^{( 1 , 1 )} ( {x}_{n} , {y}_{nm} , t ) ] {h}_{n} ( x ) {h}_{nm} ( y ) , \qquad ( 32 )$$

where v^{(i,j)}(xₙ,yₙₘ,t) is simultaneously the i-th derivative with respect to x of v(x,y,t) and the j-th derivative with respect to y of v(x,y,t) at x=xₙ and y=yₙₘ. These calculations can be repeated to obtain v(x,y,t) from v(xₙ,y,t) and its derivatives. That is:

$$\begin{matrix}υ ( x , y , t ) = {\sum }_{n = 0}^{{N}_{z} - 1} {\sum }_{m = 0}^{{N}_{y} - 1} [ υ ( {x}_{n} , {y}_{nm} , t ) + ( y - {y}_{nm} ) {η}^{( 0 , 1 )} ( {x}_{n} {y}_{nm} , t ) + ( x - {x}_{n} ) {η}^{( 1 , 0 )} ( {x}_{n} , {y}_{nm} , t ) + ( x - {x}_{n} ) ( y - {y}_{nm} ) {η}^{( 1 , 1 )} ( {x}_{n} , {y}_{nm} , t ) ] {h}_{n} ( x ) {h}_{nm} ( y ) , & ( 33 ) \\ {η}^{( 0 , 1 )} ( {x}_{n} , {y}_{nm} , t ) = {υ}^{( 0 , 1 )} ( {x}_{n} , {y}_{nm} , t ) - 2 {k}_{1} ( {x}_{n} ) υ ( {x}_{n} , {y}_{nm} , t ) , & ( 34 ) \\ {η}^{( 1 , 0 )} ( {x}_{n} , {y}_{nm} , t ) = {υ}^{( 1 , 0 )} ( {x}_{n} , {y}_{nm} , t ) - 2 {k}_{1} ( {y}_{mn} ) υ ( {x}_{n} , {y}_{nm} , t ) , & ( 35 ) \\ {η}^{( 1 , 1 )} ( {x}_{n} , {y}_{nm} , t ) = {υ}^{( 1 , 1 )} ( {x}_{n} , {y}_{nm} , t ) - 2 {k}_{1} ( {x}_{n} ) {υ}^{( 1 , 0 )} ( {x}_{n} , {y}_{nm} , t ) - 2 {k}_{1} ( {y}_{mn} ) {υ}^{( 0 , 1 )} ( {x}_{n} , {y}_{nm} , t ) + 4 {k}_{1} ( {x}_{n} ) {k}_{1} ( {y}_{nm} ) υ ( {x}_{n} , {y}_{nm} , t ) , & ( 36 )\end{matrix}$$

and where v^{(i,j)}(xₙ,yₙₘ,t) is simultaneously the i-th derivative with respect to x of v(x,y,t) and the j-the derivative with respect to y of v(x,y,t) at x=xₙ and y=yₙₘ. Equation (33) can be expanded to include derivatives of v of an order higher than the ones considered in this equation. By using a coordinate transformation, horizontal parallel lines or different orientations (e.g., different azimuths) can be regularized, as illustrated in FIG. 2C. Notably, a successful application of these data-reconstruction formulas may require that seismic sensors lie on straight lines parallel to the y axis (crosslines) (e.g., as illustrated in FIG. 2B). However, these lines are not necessarily equally spaced, and the points on each line need not be uniformly distributed.

Lagrange Interpolation for Circular Lines of Sources and Seismic Sensors

Considering v(x,y,t) as a 3D shot gather or a 3D seismic sensor gather only, the Cartesian coordinates, x and y, can be transformed into polar coordinates, as follows:

x=r cos φ, y=r sin φ, (37)

where 0≦φ<2π, r≧0. Thus, a 3D gather can be described as v(r,φ,t), instead of as v(x,y,t). Angle φ represents the azimuthal angles. The results obtained in equations (32)-(36) for parallel lines in Cartesian coordinates can be extended to polar coordinates for the two particular cases shown in FIGS. 2D and 2E. The case shown in FIG. 2D is a set of non-uniform samples in circular lines. In this case, the x coordinate can be replaced by the azimuth φ, and the y coordinate can be replaced by the radius of circular lines. The case shown in FIG. 2E is a set of non-uniform samples in radial lines. The x coordinate can be replaced by r, and the y coordinate can be replaced by φ. However, care can be taken when selecting the interpolation function because v(r,φ,t) is periodic in φ and non-periodic in r by definition. The following may be considered to facilitate the use of the Lagrange interpolation function:

$$\begin{matrix}υ ( x , t ) = {\sum }_{n = 0}^{N - 1} υ ( nΔ x , t ) {h}_{n} ( x ) , & ( 38 ) \\ where & \\ \begin{matrix}{h}_{n} ( x ) = {\sum }_{k = - ∞}^{∞} \frac{sin [ π ( x - nΔ x - kX ) / Δ x ]}{π ( x - nΔ x - kX ) / Δ x} \\ = \frac{sin [ π ( x - nΔ x ) / Δ x ]}{N π} {\sum }_{k = - ∞}^{∞} \frac{{( - 1 )}^{kN}}{[ ( x - nΔ x ) / ( NΔ x ) ] - k} ,\end{matrix} & ( 39 )\end{matrix}$$

which is valid for nonperiodic signals along the r-axis. It may be useful to work with the following function:

$$u ( r , φ , t ) = \{ \begin{matrix}υ ( r , φ , t ) , & r \geq 0 \\ υ ( - r , φ + π ) , & r < 0\end{matrix} \qquad ( 40 )$$

instead of v(r,φ,t) itself. Basically, u(r,φ,t) may enable extending v(r,φ,t) to a new coordinate system, where −∞<r′<∞. Thus the interpolation along r can be performed by using equation (39).

The data reconstructions of the two configurations in FIGS. 2D and 2E can be considered with more specificity. Starting with the circular lines, it may be assumed that u(r,φ,t) is non-uniformly sampled along non-uniformly spaced circles (e.g., as depicted in FIG. 2D). The sampling sequence can be defined as {rₙ}, with n varying from −∞ and +∞, as representing circles with radius rₙ centered at the origin and {φₙₘ} as a set of azimuths which define the non-uniform samples on circle rₙ, with m varying from 0 to N−1. It can be assumed that u(r,φ,t) is bandlimited to the circular disc of radius R. If {rₙ} satisfy the following:

$$\begin{matrix}\vert {r}_{n} - \frac{n}{R} \vert < \frac{1}{4 R} , & ( 41 ) \\ \vert {r}_{n} - {r}_{m} \vert > 0 for n \neq m , & ( 42 )\end{matrix}$$

then any seismic signal u(r,φ,t) can be perfectly reconstructed from its non-uniform samples by using equation (32) and replacing x with r, xₙ with rₙ, y with φ, yₙₘ with φₙₘ, and v with u.

Considering the case in which the samples of v(r,φ,t) lie on non-uniformly spaced radial lines (e.g., as depicted in FIG. 2E), any seismic signal u(r,φ,t) can be perfectly reconstructed from its non-uniform samples by replacing x with φ, xₙ with φₙ, y with r, yₙₘ with rₙₘ, and v with u in equation (32). For the interpolation functions, hₙₘ(r) is the interpolation function given in equation (39). However, the interpolation function given in equation (39) may not be used directly for hₙ(φ) because the period of u(r,φ,t) along φ is now X=π instead of X=2π. As can be seen in FIG. 2E, each radial line may provide two samples of the signal in φ coordinates. Therefore the number N of the samples in the azimuthal coordinate may always be even. Moreover, it can be observed that these non-uniform azimuthal samples from the set of periodic non-uniform samples, with the period being π and the number of elements per period being M=N/2. By using the same algebra as above, the following interpolation function for φ can be determined:

$${h}_{n} ( φ ) = {cos}^{2} [ \frac{( φ - {φ}_{n} )}{2} ] {\prod }_{m = 0 , m \neq n}^{M - 1} \frac{sin ( φ - {φ}_{m} )}{sin ( {φ}_{n} - {φ}_{m} )} . \qquad ( 43 )$$

The derivatives of u=u(r,φ,t) with respect to r and φ can be obtained from their Cartesian counterparts, as follows:

$$\begin{matrix}\frac{\partial u}{\partial r} = \frac{\partial u}{\partial x} \frac{\partial x}{\partial r} + \frac{\partial u}{\partial y} \frac{\partial y}{\partial r} = \frac{\partial u}{\partial x} cos φ + \frac{\partial u}{\partial y} sin φ , & ( 44 ) \\ \frac{\partial u}{\partial φ} = \frac{\partial u}{\partial x} \frac{\partial x}{\partial φ} + \frac{\partial u}{\partial y} \frac{\partial y}{\partial r} = - r [ \frac{\partial u}{\partial x} sin φ - \frac{\partial u}{\partial y} cos φ ] , & ( 45 ) \\ \begin{matrix}\frac{{\partial }^{2} u}{\partial r \partial φ} = \frac{{\partial }^{2} u}{\partial {x}^{2}} \frac{\partial x}{\partial r} \frac{\partial x}{\partial φ} + \frac{{\partial }^{2} u}{\partial {y}^{2}} \frac{\partial y}{\partial r} \frac{\partial y}{\partial φ} + \frac{{\partial }^{2} u}{\partial x \partial y} [ \frac{\partial x}{\partial r} \frac{\partial y}{\partial φ} + \frac{\partial y}{\partial r} \frac{\partial x}{\partial φ} ] \\ = - \frac{r}{2} [ \frac{{\partial }^{2} u}{\partial {x}^{2}} sin ( 2 φ ) - \frac{{\partial }^{2} u}{\partial {x}^{2}} sin ( 2 φ ) - 2 \frac{{\partial }^{2} u}{\partial x \partial y} cos ( 2 φ ) ] .\end{matrix} & ( 46 )\end{matrix}$$

Notably, these formulas can be used for interpolations involving derivatives.

Accordingly, in some embodiments, a new Lagrange interpolation for non-uniformly sampled data has been developed and employed. In some embodiment, it is assumed that the input includes wavefield and derivatives of the wavefields. In some embodiments the size of the gap between seismic sensors is directly related to the order of derivatives of the wavefields and not to a classical sampling theorem. In some embodiments, because the order of derivatives in most cases is limited to one or two, the average gap between seismic sensors is relative small, (e.g., about 20 m for the first order of derivative and about 30 m for the second order of derivatives). In some embodiments, to increase this gap and even the overall data aperture, virtual seismic sensors can be employed for each data components, including their derivatives, to allow even bigger gaps between real seismic sensors. In some embodiments, with access to higher-order cumulant tensors this gap can be relatively large (e.g., larger than 1 km in each spatial direction). It should be noted, however, that the sixth-and higher-order cumulants of seismic data are often lower than the accepted level of a signal-to-noise ratio of the data and, thus, may not be useful in practice. In some embodiments, by limiting the concept of virtual array to fourth-order cumulants and using the Lagrange formula with first order derivatives, such as those described herein, some gaps in data can be large (e.g., greater than about 20 m×20 m and up to about 100 m×100 m or more). It should be noted, however, if there are no large gaps in the seismic data, a fine sampling of even noise can be provided. In some embodiments, such a fine sampling can be used to filter noise or events outside the seismic bandwidth. Moreover, this fine sampling can help to improve the resolution of seismic imaging, thereby enabling the generation of a seismic image of enhanced resolution.

Compressive Sensing and Data Regularization

Assuming that Δx is a spatial sampling interval for which our seismic dataset (e.g., seismic data 120) is non-aliased, then compressive sensing, multicomponent recordings, and the mixing-matrix estimation can be used to illustrate sampling of the same dataset non-uniformly, with an average sampling interval that is six or more times greater than that of Δx. This can enable the use of the very large seismic sensors spacings, which can be especially useful in OBS, land seismic, and earthquake tomography.

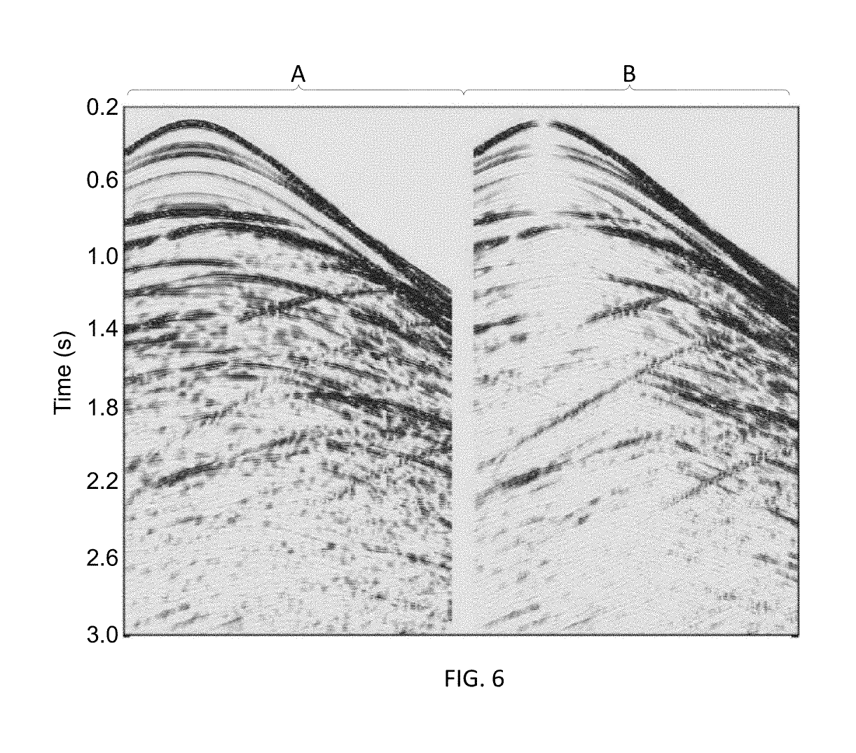

The following provides brief discussions of figures that illustrate the execution and advantages of certain regularization techniques, and that are referenced throughout this discussion. FIG. 6 illustrates shot gathers of a non-uniform real seismic sensor array in accordance with one or more embodiments. Two shot gathers are illustrated in portions A and B, respectively, of FIG. 6. The seismic sensor locations are defined as xₙ=nΔx+Eₙ, with Δx=16 m and Eₙ ∈ [−4 m, 4 m], and with (a) the pressure and (b) the first derivative of the pressure being recorded with respect to x for portions A and B, respectively.

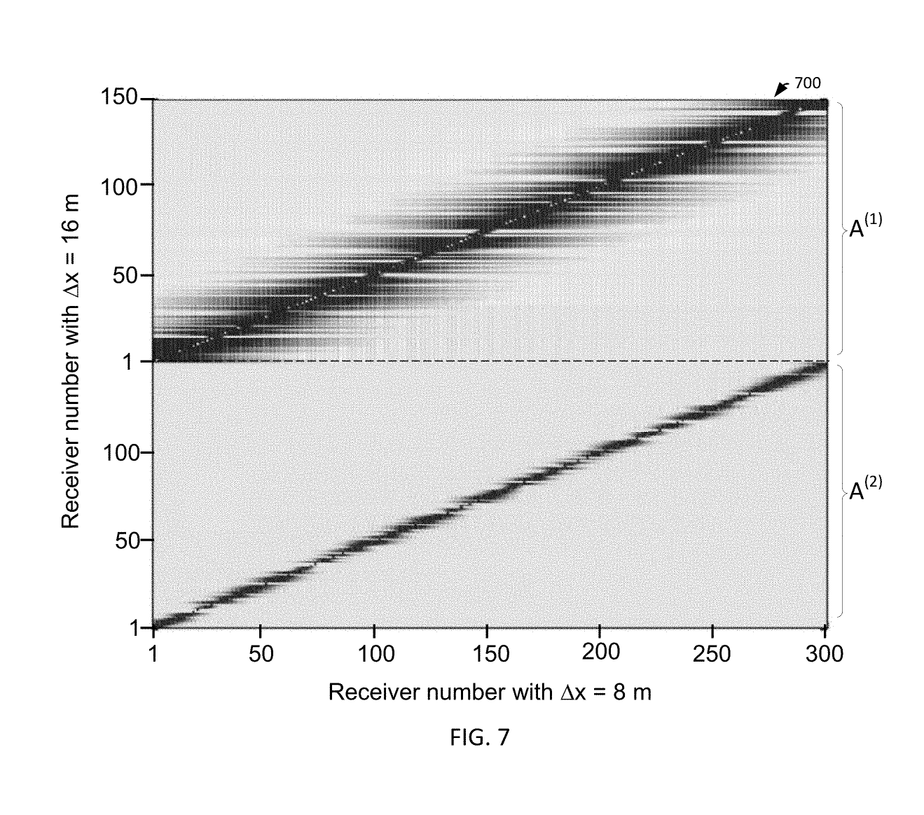

FIG. 7 illustrates a mixing-matrix 700 in accordance with one or more embodiments. This can be the interpolation matrix that is referred to as a mixing-matrix because it can allow mixing of regularized data to produce non-uniformly sampled data. The illustrated embodiment includes two parts for two component data: part A⁽⁰⁾ relates the data to regularize the pressure of non-uniformly sampled; and part A⁽¹⁾ relates the data to regularize the first derivative of the pressure data with respect to x for the same non-uniform distribution of seismic sensors. A mixing-matrix is independent of time and can enable the connection of non-uniform data to uniform data. The inversion of the mixing-matrix is not possible when the problem is undetermined, as it is here in some embodiments. In some embodiments, the direct-wave arrivals are determined and the mixing matrix is estimated to correspond the direct-wave arrivals. In some embodiments, data-concentration directions are determined from histograms of the multi-components and the elements of the mixing matrix are determined as the data-concentration directions. In some embodiments, the mixing matrix is determined by constructing a statistical model that matches the distribution of data with angles representing the directions of data concentration, and the mixing matrix is estimated using the peak values of the statistical model. In some embodiments, there are many T-F-X (time-frequency-space) points where only a single sample of a regularized data point contribute to multiple components, and the T-F-X points where more than one sample contributes to the non-uniformly sampled data are ignored.

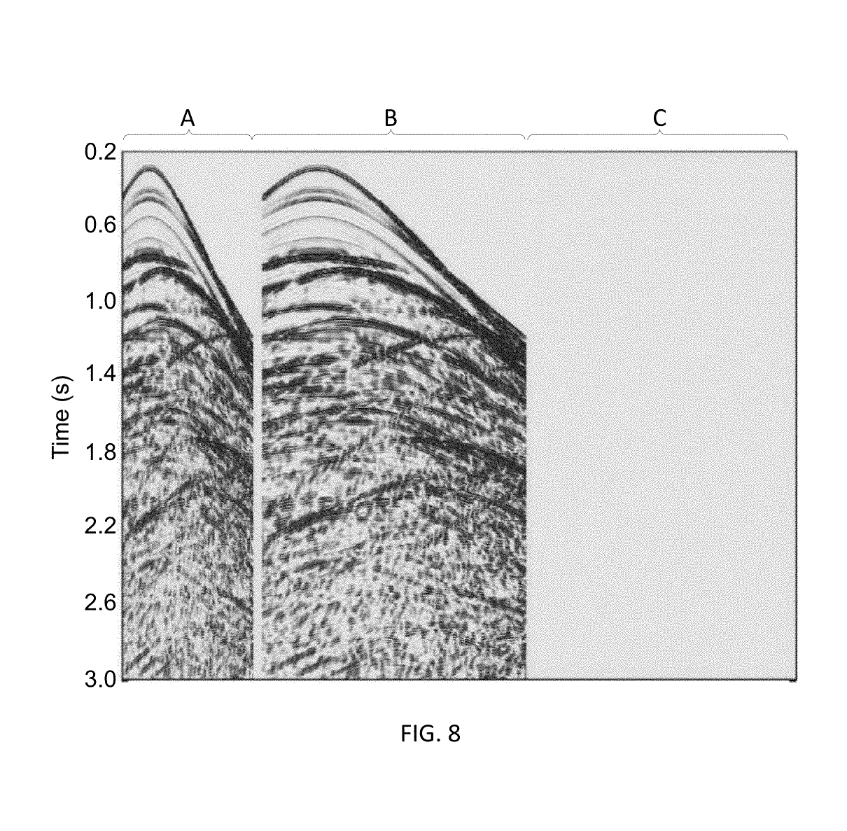

FIG. 8 illustrates shot gathers in accordance with one or more embodiments. Portion A of FIG. 8 illustrates a shot gather of a non-uniform real seismic sensor array, with the seismic sensor locations being defined as xₙ=nΔx+Eₙ, with Δx=16 m and Eₙ ∈ [−4 m, 4 m]. Portion B of FIG. 8 illustrates a reconstructed shot gather for a uniform seismic sensor array, with Δx=8 m, generated via use least square optimization. Portion C of FIG. 8 illustrates differences between the reconstructed data in portion B of FIG. 8 and the actual data recorded by real seismic sensors at the same locations of the interpolated data.

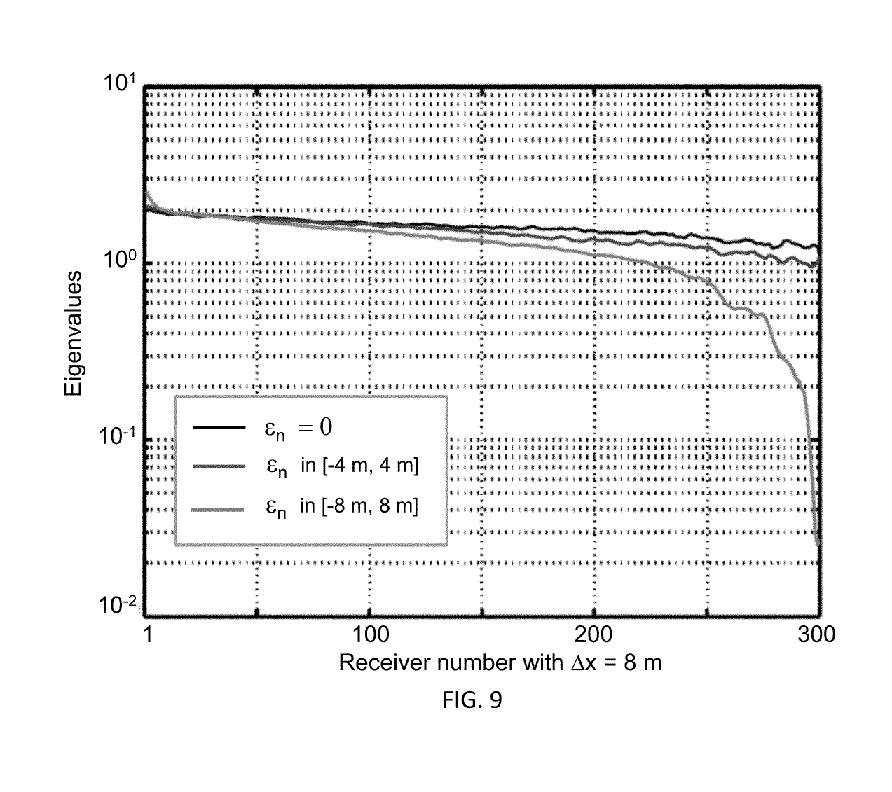

FIG. 9 illustrates eigenvalues of the mixing-matrix of the interpolation function, A⁽⁰⁾, for Eₙ=0, Eₙ ∈ [−4 m, 4 m], and Eₙ ∈ [−8 m, 8 m], with the seismic sensor locations being defined as xₙ=nΔx+Eₙ, with Δx=16 m.

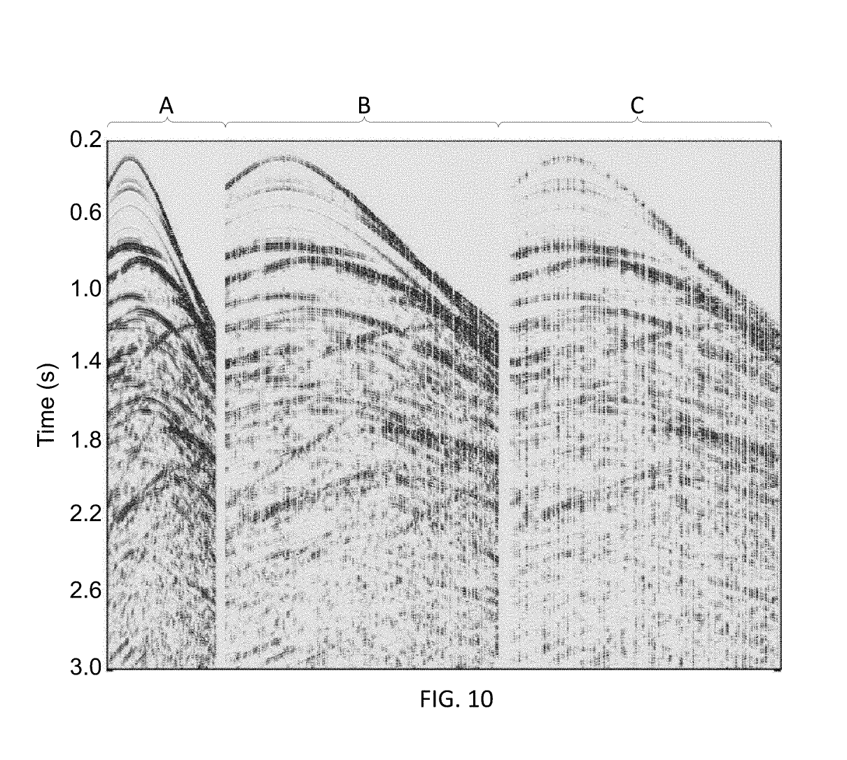

FIG. 10 illustrates shot gathers in accordance with one or more embodiments. Portion A of FIG. 10] illustrates a shot gather of a non-uniform real seismic sensor array, with the seismic sensor locations being defined as xₙ=nΔx+Eₙ, with Δx=20 m and Eₙ ∈ [−4 m, 4 m]. Portion B of FIG. 10 illustrates the reconstructed shot gather for a uniform seismic sensor array, with Δx=8 m, generated using the sparse optimization in equation (66). Portion C of FIG. 10 illustrates differences between the reconstructed data in portion B of FIG. 10 and the actual data recorded by real seismic sensors at the same locations of the interpolated data.

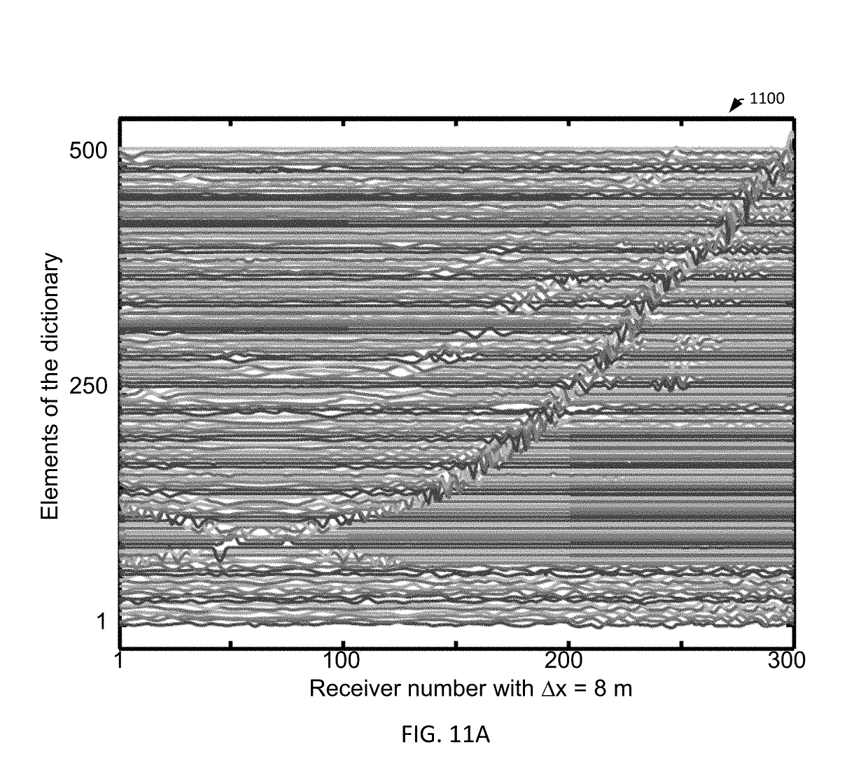

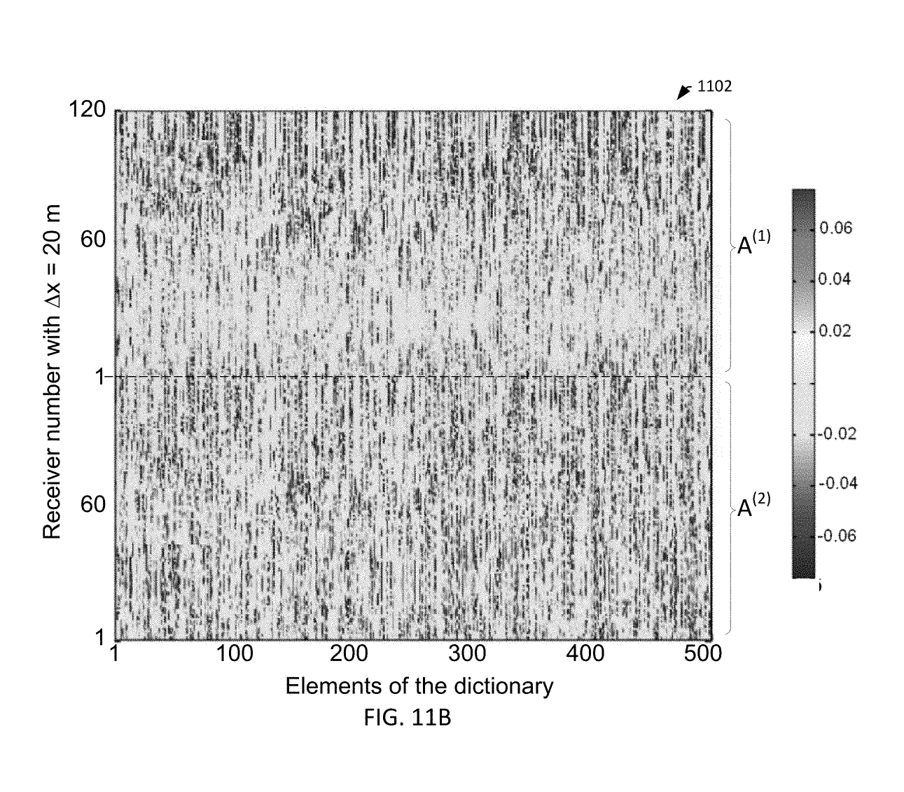

FIG. 11A illustrates a dictionary 1100 of sparse representation (Ψ) obtained using nonnegative-matrix factorization in accordance with one or more embodiments. The dictionary 1100 can include a mapping of seismic data that is not sparse enough for compressive sensing (e.g., it does not have a significant amount gaps such that less than 5% of the seismic data is represented by zeros indicating no seismic event being sensed) to a space where the data is relatively sparse (e.g., 60% or more of the seismic data is represented by zeros indicating no seismic event being sensed).

FIG. 11B illustrates a mixing-matrix (or measurement matrix) 1102 which is the product of A and Ψ.

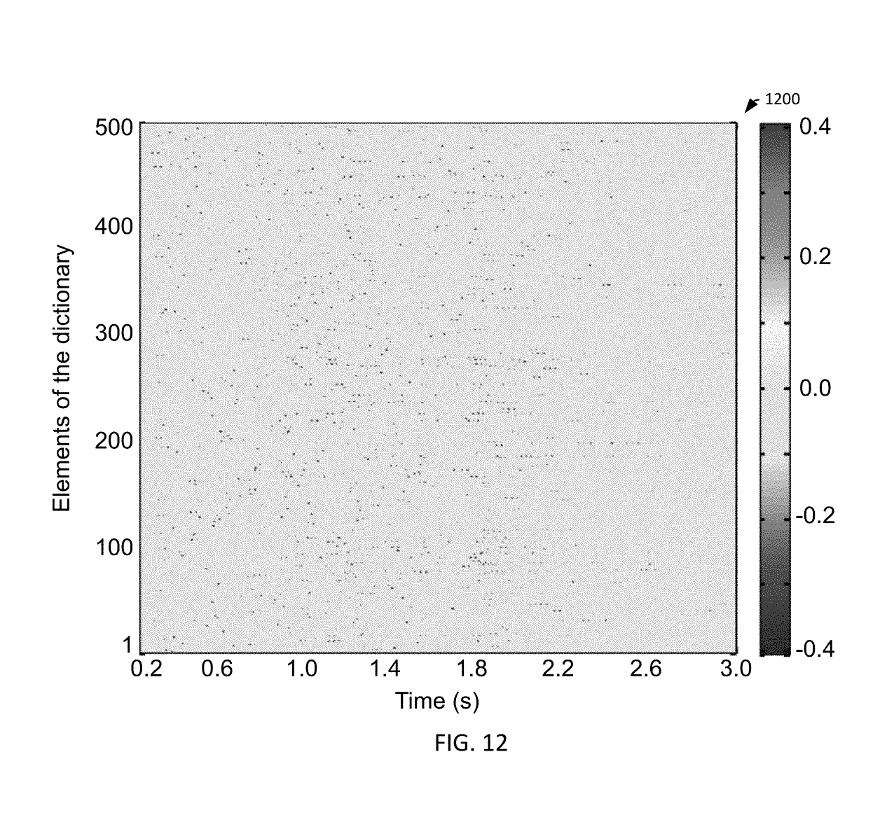

FIG. 12 illustrates stochastic coefficients 1200 representing P^{(c)} in a sparse-representation domain. Notably, this representation of seismic data is relatively sparse.

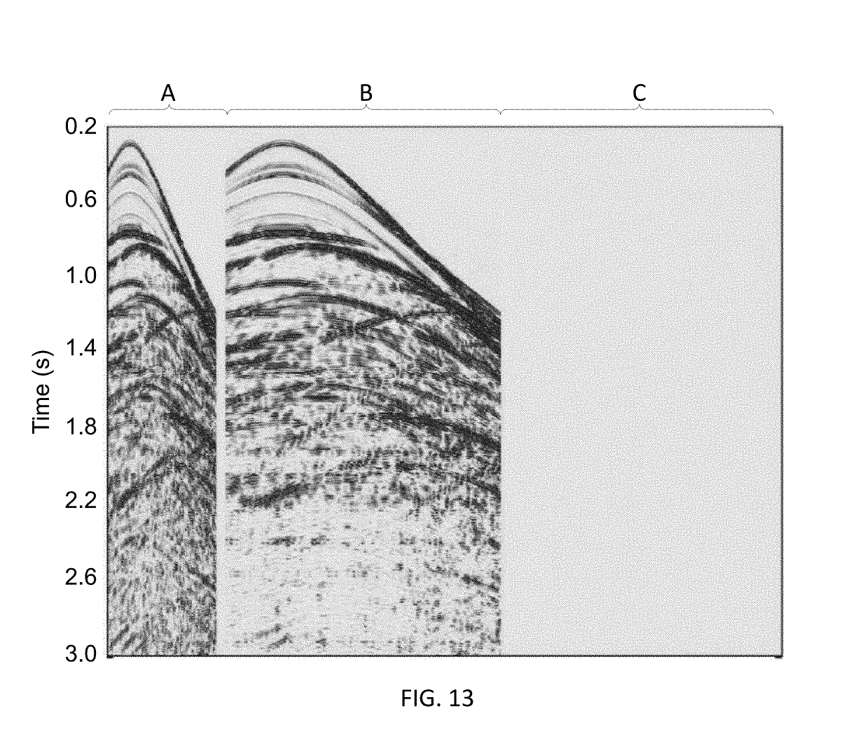

FIG. 13 illustrates shot gathers in accordance with one or more embodiments. Portion A of FIG. 13 illustrates a shot gather of a non-uniform real seismic sensor array, with the seismic sensor locations being defined as xₙ=nΔx+Eₙ, with Δx=20 m and Eₙ ∈ [−4 m, 4 m]. Portion B of FIG. 13 illustrates a reconstructed shot gather for a uniform seismic sensor array, with Δx=8 m, generated using the sparse optimization in equation (56), and which include the sparse representation. Portion C of FIG. 13 illustrates differences between the reconstructed data in portion B of FIG. 13 and the actual data recorded by real seismic sensors at the same locations of the interpolated data.

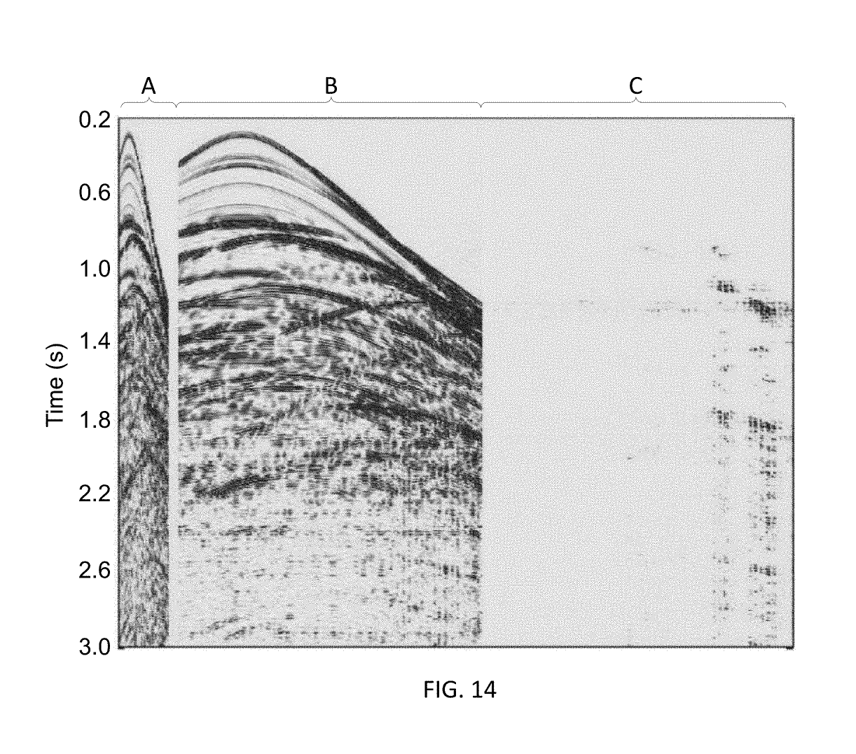

FIG. 14 illustrates shot gathers in accordance with one or more embodiments. Portion A of FIG. 14 illustrates a shot gather of a non-uniform real seismic sensor array, with the seismic sensor locations being defined as xₙ=nΔx+Eₙ, with Δx=48 m and Eₙ ∈ [−4 m, 4 m]. Portion B of FIG. 14 illustrates a reconstructed shot gather for a uniform seismic sensor array, with Δx=8 m, generated using the sparse optimization in equation (56), and which include the sparse representation. Portion C of FIG. 14 illustrates differences between the reconstructed data in Portion B of FIG. 14 and the actual data recorded by real seismic sensors at the same locations of the interpolated data.

Two issues may be addressed to provide for effective use compressive sensing to regularize very sparsely sampled seismic data. One issue is to seek a more-realistic alternative measurement matrix than a random Gaussian matrix. For example, one solution to this issue is to use the Lagrange-interpolation matrices as the measurement matrix. The other issue involves finding a sparsity representation which significantly increases the sparsity of seismic-data representation. One solution is to use matrix decomposition (e.g., as described in Ikelle, Luc. Coding and Decoding: Seismic Data, Volume 39. Elsevier, 2010), such as independent component analysis (ICA) decomposition and Non-negative matrix factorization (NMF) decomposition. One can further improve the effectiveness of compressive sensing by using multicomponent data.

Data Regularization without Sparse Representation

Without sparse representation (e.g., less than 5% of the seismic data is represented by zeros indicating no seismic event being sensed), normal matrix inversion may be used when the number of equations equals the number of unknowns.

With regard to data regularization without sparse representation, pressure data can be represented in the following form:

P⁽⁰⁾(xᵣ,t)=ΣₓA⁽⁰⁾(xᵣ,x)P^{(c)}(x,t) (47)

in discrete form as the following:

Pᵣₜ⁽⁰⁾=ΣₓAᵣₓ⁽⁰⁾Pₓₜ^{(c)} (48)

and in compact notation as the following:

$$\underbrace{{P}^{( 0 )}}_{{N}_{r} {xN}_{t}} = \underbrace{{A}^{( 0 )}}_{{N}_{r} {xN}_{c}} \underbrace{{P}^{( c )}}_{{N}_{c} {xN}_{t}} \qquad ( 49 )$$

where xᵣ represents data of a set of non-uniformly sampled data, x represents data of a set of uniformly sampled data and t is the corresponding recording time, Nᵣ is the number of seismic sensors corresponding to the set of non-uniformly sampled data, N_{c} is the number of seismic sensors corresponding to the set of uniformly sampled seismic data and Nₜ is the number of time steps, and where Pᵣₜ⁽⁰⁾=P⁽⁰⁾(xᵣ,t) are the recorded data, Pₓₜ^{(c)}=P^{(c)}(x, t) are the resampled data to be recovered, and Aᵣₓ=A(xᵣ,x) is the mixing-matrix. The following represents a typical mathematical structure of this mixing-matrix:

$$\begin{matrix}{A}^{( 0 )} ( {x}_{r} , x ) = \frac{G ( x )}{( x - {x}_{r} ) {G}^{′} ( {x}_{r} )} & ( 50 ) \\ with & \\ G ( x ) = ( x - {x}_{0} ) {\prod }_{n = 1}^{∞} ( 1 - \frac{{x}^{2}}{{x}_{r}^{2}} ) & ( 51 )\end{matrix}$$

A⁽⁰⁾(xᵣ,x) can define uniform and non-uniform seismic sensors arrays (e.g., as described in Ikelle, 2010). The dimension of Pᵣₜ⁽⁰⁾ is an Nᵣ×Nₜ matrix, that of Pₓₜ^{(c)} is an N_{c}×Nₜ matrix, and that of Aᵣₓ is an Nᵣ×N_{c} matrix. In compact form, Pᵣₜ⁽⁰⁾ is described by the matrix P⁽⁰⁾, Pₓₜ^{(c)} by the matrix P^{(c)}, and Aᵣₓ⁽⁰⁾ by the matrix A⁽⁰⁾. In OBS data, especially the data of PRM (permanent reservoir monitoring), the spacing interval can unfortunately be as large as six or more times Δx (e.g., Nᵣ≧N_{c}/6). In other words, generally ending with an underdetermined system in these cases (with fewer equations than unknowns) for each time step. Fortunately, multiple-component data can be recorded, as described herein. Suppose that J components are recorded which are directly linked to P^{(c)} data; for example, the pressure P⁽⁰⁾ and its derivatives with respect to x, which can be denoted in vector form as P⁽¹⁾, P⁽²⁾ . . . P^{(J)}. These components can be defined as follows:

P^{(j)}(xᵣ,t)=ΣₓA^{(j)}(xᵣ,x)P^{(c)}(x,t) (52)

in discrete form as the following:

Pᵣₜ^{(j)}ΣₓAᵣₓ^{(j)}Pₓₜ^{(c)} (53)

and in compact notation as the following:

$$\begin{matrix}\underbrace{{P}^{( j )}}_{{N}_{r} {xN}_{t}} = \underbrace{{A}^{( j )}}_{{N}_{r} {xN}_{c}} \underbrace{{P}^{( c )}}_{{N}_{c} {xN}_{t}} & ( 54 ) \\ where & \\ {A}^{( j )} ( {x}_{r} , x ) = \frac{{\partial }^{j} {A}^{( 0 )} ( {x}_{r} , x )}{\partial {x}_{r}^{j}} & ( 55 )\end{matrix}$$

Given that all the components are recorded at the same points, the components in vector-matrix form can be arranged as follows:

$$\begin{matrix}\underbrace{P}_{( {JxN}_{r} ) {xN}_{t}} = \underbrace{{A}^{( j )}}_{( {JxN}_{r} ) {xN}_{c}} \underbrace{{P}^{( c )}}_{{N}_{c} {xN}_{t}} & ( 56 ) \\ P = {[ {P}^{( 0 )} , {P}^{( 1 )} , … , {P}^{( J )} ]}^{T} & ( 57 ) \\ A = {[ {A}^{( 0 )} , {A}^{( 1 )} , … , {A}^{( J )} ]}^{T} & ( 58 )\end{matrix}$$

With the objective to recover P^{(c)} for a given P and A. Assuming that (J×Nᵣ)≧N_{c} (there are more equations than unknowns), P^{(c)} can be recovered by using least-squares optimization or matrix inversion (e.g., as described in Ikelle & Amundsen, 2005). If the number of components is so small that (J×Nᵣ)<N_{c}, the problem of reconstructing regularized data as a sparse-optimization problem can be solved as follows:

$$\begin{matrix}{min}_{{P}^{( c )}} & {‖ {P}^{( c )} ‖}_{1}\end{matrix} subject to P = {AP}^{( c )} \qquad ( 59 )$$

Compressive sensing can include assuming that the mixing-matrix is known, and, thus, as discussed above, the mixing-matrix can be constructed from the Lagrange interpolation (e.g., as described in Ikelle & Amundsen, 2005). The mixing matrix can be an interpolation matrix that links the recorded data with the desired resampled data. Alternatively, the mixing-matrix can be recovered from the statistical methods (e.g., as described in Ikelle, 2010), even when equation (56) is underdetermined, because the mixing-matrix is time-independent. In some embodiments, the direct-wave arrivals are determined and the mixing matrix is estimated to correspond the direct-wave arrivals. In some embodiments, data-concentration directions are determined from histograms of the multi-components and the elements of the mixing matrix are the data-concentration directions. In some embodiments, the mixing matrix is determined by constructing a statistical model that matches the distribution of data with angles representing the directions of data concentration, and the mixing matrix is estimated using the peak values of the statistical model. In some embodiments, there are many T-F-X (time-frequency-space) points where only a single sample of a regularized data point contribute to multiple components, and the T-F-X points where more than one sample contributes to the non-uniformly sampled data are ignored. Moreover, recovering the mixing-matrix this way (e.g., instead of through-Lagrangian interpolation matrices) allows data-acquisition errors to be taken into account. In accordance with the above description, data regularization without sparse representation can include the following:

(1) Recording J component data;

(2) Constructing the mixing-matrix, A; and

(3) Reconstructing P^{(c)} by using least-square optimization or sparse optimization.

Data Regularization with Sparse Representation

Sparse representation may refer to the new data domain where the seismic data has so many zeros (e.g., 60% or more of the seismic data is represented by zeros indicating no seismic event being sensed) so that the problem can be solved. With regard to data regularization with sparse representation, P^{(c)}(x,t) can be described as the linear superposition of some features that can be extracted from the same dataset. If these features are denoted by the functions ψₖ(x), then P^{(c)}(x,t) can be expressed as follows:

P^{(c)}(x,t)=Σₖ₌₁^{M}ψₖ(x)βₖ(t) (60)

where βₖ(t) are stochastic coefficients. When the M functions ψₖ(x) are taken as a set, they constitute a dictionary. An optimal choice of functions ψₖ(x) in this context is equivalent to having M much smaller than N_{c}. The dictionary and the stochastic coefficients can be reconstructed, using, for example, a nonnegative matrix factorization (NMF) technique. By using equations (56) and (60), the regularization equation can be expressed as follows:

P(xᵣ,t)=Σₖ₌₁^{M}Ã(xᵣ,k)βₖ(t) (61)

in discrete form as the following:

Pᵣₜ=Σₖ₌₁^{M}Ãᵣₖβₖₜ (62)

and in compact notation as the following:

$$\begin{matrix}{\underbrace{P}}_{{N}_{r} {xN}_{t}} = \underbrace{\tilde{A}}_{{N}_{r} xM} \underbrace{β}_{MxNt} \\ where & ( 63 ) \\ \tilde{A} ( {x}_{r} , k ) = {\sum }_{x} A ( {x}_{r} , x ) {ψ}_{k} ( x ) & ( 64 )\end{matrix}$$

The objective may, again, be to recover the coefficient sets P^{(c)} for a given P and A. With the above formulation, the coefficient set, {βₖ(t)} can be sought and then deduce P^{(c)} using equation (60). If it is assumed that (J×Nᵣ)≧M (e.g., there are more equations than unknowns), recovery of β can be accomplished by using the least-squares optimization or the classical matrix inversion. If the number of components is so small that (J×Nᵣ)<M, the problem of reconstructing regularized data as a sparse-optimization problem can be solved as follows:

$$\begin{matrix}{min}_{β} & {‖ β ‖}_{1} subject to P = \tilde{A} β\end{matrix} \qquad ( 65 )$$

There may be cases in which the number of features, M, is smaller than the number of seismic sensors, N_{c}. In these cases the requirements of the seismic sensor spacing can be reduced.

In accordance with the above description, data regularization with sparse representation can include the following:

(1) Recording J component data;

(2) Constructing the mixing-matrix, A;

(3) Constructing a dictionary that increases the sparse representation of seismic data;

(4) Constructing a new mixing-matrix, Ã;

(5) Reconstructing β by using least-squares optimization or sparse optimization; and

(6) Obtaining regularized data using β and the dictionary of the sparse representation.

The following discussion provides some examples of applications of the disclosed compressive sensing and data regularization techniques.

Example Case 1—In one example embodiment, the pressure and its first derivative with respect to x is available (e.g., J=2), the other parameters are Nᵣ=150, N_{c}=300, and Nₜ=1400 and the seismic sensor locations can be defined as follows:

xₙ=nΔx+εₙ (66)

with Δx=16 m, where n is the discretization of the dara in space and where εₙ is extracted from a uniform seismic sensors array in the interval [−4 m, 4 m]. εₙ can be used in this interval through the examples included in this section. FIG. 6 shows the two recorded components. The average seismic sensor spacing is 16 m, and yet these data are aliased because the refracted energy requires the sampling to be about 8 m or less. A goal is to seek to recover the regularized data with a seismic sensor spacing of 8 m. FIG. 7 illustrates the mixing-matrix, A, that is associated with this configuration. Because (J×Nᵣ)=N_{c} (e.g., the number of equations equals the number of unknowns), P^{(c)} can be recovered using the classical matrix inversion. A representation of the resulting regularized data is illustrated in portion B of FIG. 8. The differences between the reconstructed uniform data and the actual computed uniform data in portion C of FIG. 8C illustrates that the data reconstruction from non-uniform samples using the solution in equation (56) is quite effective. The stability of this data reconstruction is illustrated in FIG. 9 by the fact that the range of variations of the eigenvalues of the mixing-matrix of the interpolation function for εₙ=0, εₙ in the interval [−4 m, 4 m], and εₙ in [−8 m, 8 m]. Notably, the range of variations of the eigenvalues of the mixing-matrix is quite small when the interval of εₙ is [−4 m, 4 m] or smaller. The range of variations of the eigenvalues increases significantly increased for when the interval of εₙ is [−8 m, 8 m]. This increase indicates that by further increasing the values of εₙ, the reconstruction can become unstable even when (J×Nᵣ)=N_{c}.

Example Case 2—In one example embodiment, Nᵣ=120 (e.g., the seismic sensor spacing is 24 m) and a 240×300 mixing-matrix is used; therefore (J×Nᵣ)<N_{c}, and, thus, the inversion of the mixing-matrix cannot be used to regularize the data, and the problem can be solved using equation (66). Notably, the results illustrated in portion B of FIG. 10 are not satisfactory. The poor results here can be attributed to the fact that the mixing-matrix is not dense. To allow an increase in the seismic sensor spacing, the sparse representation in equation (61) can be used. FIG. 11A illustrates the dictionary 1100 of this representation, with M=500. By combining this dictionary 1100 with the mixing-matrix in the time-space domain, as described in equation (65), the new mixing-matrix 1102 of FIG. 11B can be obtained. Notably, the mixing 1102 is quite dense compared to that of mixing-matrix 700 in the time-space domain (see, e.g., FIG. 7). A 240×500 mixing-matrix can be used; therefore (J×Nᵣ)<M, and thus, the inversion of the mixing-matrix cannot be used to regularize data. The sparse-optimization problem in (66) is solved. Notably, the results shown in portion B of FIG. 14 are now quite satisfactory because the mixing-matrix 1102 of FIG. 11B is quite dense and β is effectively quite sparse as shown by the results in FIG. 12. The regularized data shown in portion B of FIG. 13 can be deduced using equation (60). The lack of difference between the reconstructed uniform data and the actual computed uniform data (illustrated in portion C of FIG. 13) shows that the data reconstruction from non-uniform samples by using the described data regularization with sparse representation is quite effective.

Example Case 3—In some instances, to allow increased seismic sensor spacing, the sparse representation of equation (61) is used. In one example embodiment, Nᵣ=120 (e.g., the seismic sensor spacing is 36 m). FIG. 11A illustrates the dictionary 1100 of this representation, with M=200. By combining this dictionary 1100 with the mixing-matrix 700 in the time-space domain, as described in equation (61), the new mixing-matrix 1102 illustrated in FIG. 11B is obtained. Notably, the mixing is quite dense compared to that of the mixing-matrix 700 in the time-space domain (see FIG. 7). A 200×200 mixing-matrix is provided; therefore (J×Nᵣ)=M, and recovery of β can be accomplished using the classical matrix inversion. The results in FIG. 12 show that β is effectively quite sparse. The regularized data shown in portion B of FIG. 13 can be deduced using equation (60). The differences between the reconstructed uniform data and the actual computed uniform data in FIG. 13C illustrates that the data reconstruction from non-uniform samples by using the described data regularization with sparse representation is quite effective.

Example Case 4—In one example embodiment, Nᵣ=50 (e.g., the seismic sensor spacing is 48 m); the receiver spacing is now six times that of the seismic sensor spacing required by the sampling theorem of uniformly distributed receivers. A 100×500 mixing-matrix is provided; therefore (J×Nᵣ)<M, and thus, the inversion of the mixing-matrix cannot be used to regularize data, and the sparse-optimization problem in (66) is solved. Notably, the results shown in portion B of FIG. 14 are still satisfactory.

In summary, dealing with the problem of very large seismic sensor spacing in seismology (and/or very large shot-point (or “seismic source”) spacing) does not necessarily imply reducing seismic sensor spacing in seismology (and/or very large shot-point spacing). The embodiments described herein demonstrate that this problem can alternately be solved by recording multiple-component data and by an effective choice of the sparse representation of seismic data for processing the seismic data.

Example Embodiments for Generating Seismic Images

In some embodiments, a seismic energy source and an array of real seismic sensors (or a “real seismic sensor array”) is provided for acquiring seismic data for a subsurface formation, the seismic energy source and the real seismic sensor array are operated to acquire seismic data for the subsurface formation, and the seismic data is processed to generate a seismic image of the subsurface formation. As described herein, various operations for assessing and developing formations, including formation and reservoir modeling, the generation of FDPs, and the designing and operating wells for producing hydrocarbons from the reservoirs can be based on the resulting enhanced seismic image.

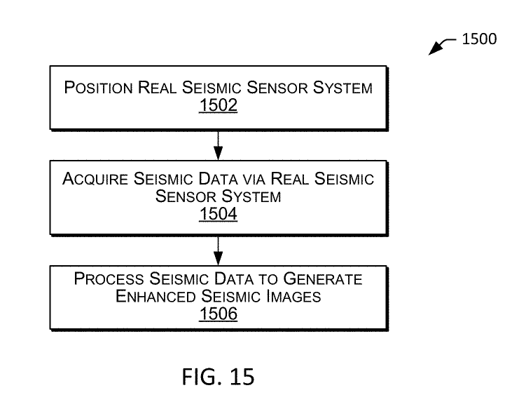

FIG. 15 is a flowchart that illustrates an example method 1500 for generating an enhanced seismic images in accordance with one or more embodiments. Method 1500 can include positioning a real seismic sensor system (block 1502), acquiring seismic data via the real seismic sensor system (block 1504), and processing the seismic data to generate enhanced seismic images (block 1506). In some embodiments, some or all of the operations of method 1500 are performed by the seismic processing system 113.

In some embodiments, positioning a real seismic sensor system (block 1502) includes physically positioning a seismic energy source and a real seismic sensor array proximate a subsurface formation for which a seismic survey is to be conducted, to provide for generation of a seismic image of the subsurface formation. For example, positioning a real seismic sensor array can include positioning a seismic energy source 110 and a real seismic sensor array 118 at the earth's surface 106, above the subsurface formation 104 to provide for generation of one or more seismic images 102 of the subsurface formation 104. In some embodiments, the real seismic sensor array 118 can have a uniform distribution (e.g., a uniform linear or grid distribution) or a non-uniform distribution (e.g., a non-uniform linear, grid, circle or star distribution) of real seismic sensors 112. The real seismic sensor array 118 can have, for example, a distribution similar that of the real seismic sensor arrays 118a, 118b, 118c, 118d and 118e described herein with regard to at least FIGS. 2A-2E.

In some embodiments, acquiring seismic data via the real seismic sensor system (block 1504) includes operating the seismic energy source and the real seismic sensor array to acquire seismic data. For example, acquiring seismic data via the real seismic sensor system can include operating the seismic energy source 110 to emit waves of seismic energy (“seismic waves”) 114 into the subsurface formation 104, and operating each of the real seismic sensors 112 of the real seismic sensor array 118 to sense resulting seismic energy waves (“seismic echoes” or “seismic wavefields”) 116 reflected by the subsurface formation 104 and to generate seismic responses (or “signal responses”) 117 corresponding to the seismic echoes 116 sensed by the real seismic sensor 112. The seismic data 120 corresponding to the seismic echoes 116 sensed by the real seismic sensors 112 (e.g., including the signal responses 117 generated by the real seismic sensors 112) can be recorded and stored, for example, in the seismic data database 122.

In some embodiments, the seismic waves 114 can include multi-component seismic waves (e.g., including horizontal P-waves and vertical S-waves) and the signal responses 117 can include corresponding multicomponent recordings of the seismic echoes 116 (e.g., including recordings of vertical S-wave components and horizontal P-wave components of the seismic echoes 116, that correspond to the components of the seismic waves 114). The S-waves may include two shear (SV and SH) wave components. In some embodiments, the multicomponent recordings include one or more derivatives of the components and the corresponding seismic data can include multi-component data including the wavefields of the components and their derivatives. For example, corresponding seismic data can include derivatives of the P-wave and/or S-wave being recorded. A signal response 117 can include various derivatives (e.g., 1^{st}, 2^{nd}, 3^{rd}, 4^{th}, 5^{th} and/or 6^{th} derivatives) of the components of the corresponding seismic echoes 116. The higher-order derivatives can produce Lagrangian series that can be subject to Lagrangian interpolation. Such series and resulting interpolations can enable the increase in sampling (e.g., the distance between seismic sensors) by a factor of two to three times.

In some embodiments, processing the seismic data to generate enhanced seismic images (block 1506) includes processing the seismic data to generate one or more enhanced seismic images of a subsurface formation. For example, processing the seismic data to generate enhanced seismic images can include processing the seismic data 120 to generate one or more enhanced seismic images 102 of the subsurface formation 104.

In some embodiments, the enhanced seismic images 102 can be used to generate one or more formation models 134, including three-dimensional representations of the various features of the subsurface formation 104. These formation models 134 can be used, for example, to identify locations of hydrocarbon reservoirs (e.g., oil and gas reservoirs) in the subsurface formation 104, and assess the ability of the hydrocarbon reservoirs to produce hydrocarbons (e.g., oil and gas). In some embodiments, a FDP 136 can be generated based on the formation models 134 (e.g., based on the identified locations of hydrocarbon reservoirs) and the ability of the hydrocarbon reservoirs to produce hydrocarbons. An FDP 136 can, for example, identify locations for drilling wells to produce the hydrocarbons and even wellbore paths (also referred to as “well trajectories”) for the respective wells. Ultimately, wells (e.g., production, injection and monitoring wells) can be drilled into the formation 104, and be operated according to the FDP 136 to efficiently produce hydrocarbons from the reservoirs.

In some embodiments, the processing of the seismic data includes generation of a “virtual sensor array” that includes representations of the real seismic sensors 112 of the real seismic sensor array 118, as well as representations of “virtual seismic sensors” generated based on the seismic data 120 acquired via the real seismic sensors 112 of the real seismic sensor array 118. As a result, the virtual sensor array can provide a representation of an extended area that is larger than the area covered by the real seismic sensor array (e.g., including virtual sensors that extend beyond the area covered by the real seismic sensors 122 of the real seismic sensor array 118 (e.g., as illustrated in FIG. 2A) and/or can provide an enhanced image of the area covered by the real seismic sensors 122 of the real seismic sensor array 118 (e.g., including representations for virtual sensors located in gaps between the real seismic sensors 112 of the real seismic sensor array 118). That is, the virtual sensor array can include a representation of a greater number of seismic sensors (e.g., including real and virtual seismic sensors) relative to the number of real seismic sensors 112 of the real seismic sensor array 118 used to acquire the corresponding seismic data 120.

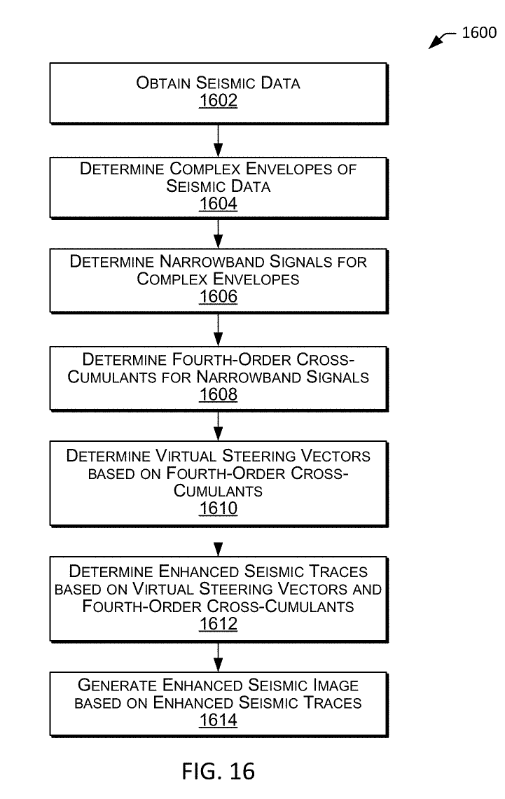

FIG. 16 is a flowchart that illustrates an example method 1600 for generating an enhanced seismic images using virtual arrays in accordance with one or more embodiments. In some embodiments, method 1600 includes obtaining seismic data (block 1602), determining complex envelopes of the seismic data (block 1604), determining narrowband signals for the complex envelopes (block 1606), determining fourth-order cross-cumulants for the narrowband signals (block 1608), determining virtual steering vectors based on the fourth-order cross-cumulants (block 1610), determining enhanced seismic traces based on the virtual steering vectors and the fourth-order cross-cumulants (block 1612), and generating an enhanced seismic image based on the enhanced seismic traces (block 1614). In some embodiments, some or all of the operations of method 1600 are performed by the seismic processing system 113.

In some embodiments, obtaining seismic data (block 1602) includes, obtaining seismic signal responses 117 from real seismic sensors 112 of the real seismic sensor array 118. The data can, for example, be expressed as described with regard to equation (1).

In some embodiments, determining complex envelopes of the seismic data (block 1604) includes, for each real seismic sensor 112 of the real seismic sensor array 118, generating a complex envelope for each seismic signal response 117 generated by the real seismic sensor 112. The determination of the complex envelope for a seismic signal response 117 can, for example, be provided as described with regard to equation (2).

In some embodiments, determining narrowband signals for the complex envelopes (block 1606) includes decomposing each complex envelope into one or more narrowband signals. This can include decomposing each seismic signal response 117 of the plurality of seismic signal responses 117 into one or more narrowband signals for the seismic signal response 117 using a filter bank (e.g., filter bank 130), with each narrowband signal including a plurality of components that each carry a single-frequency sub-band of the original signal response 117. This can also include defining a plurality of narrowband signals, based on the plurality of seismic signal responses 117 for the (I) statistically independent seismic signals from the plurality of (L) real seismic sensors 112. The decomposition of a complex envelope into one or more narrowband signals can, for example, be provided as described with regard to equation (3).

In some embodiments, determining fourth-order cross-cumulants for the narrowband signals (block 1608) includes determining fourth-order cross-cumulants for each of the narrowband signals for each of the (I) statistically independent seismic signals. The determination of fourth-order cross-cumulants for each of the narrowband signals can, for example, be provided as described with regard to equations (6)-(8).

In some embodiments, determining virtual steering vectors based on the fourth-order cross-cumulants (block 1610) includes determining a virtual steering vector for each of the each of the (I) statistically independent seismic signals based on the fourth-order cross-cumulants. This can include defining a plurality of virtual steering vectors that are each a true steering vector for a virtual array of (L²) virtual sensors. The determination of the virtual steering vectors can, for example, be provided as described with regard to equations (9)-(12).

In some embodiments, determining enhanced seismic traces based on the virtual steering vectors and the fourth-order cross-cumulants (block 1612) includes determining enhanced seismic traces 133 from the fourth-order cross-cumulants and the virtual steering vectors. The enhanced seismic trace can include the plurality of fourth-order crosscumulants for the plurality of narrowband signals and the plurality of virtual steering vectors for each of the plurality of (I) statistically independent seismic signals. The steering vectors and fourth-order cross-cumulants can be processed, for example, according to known fourth-order direction-finding algorithms. The array response can be expressed as complex numbers, and be decomposed into narrow-bands, a virtual array can be generated through computing of fourth-order cross-cumulants for each narrow-band, and the virtual array responses of the narrow-band signals can be regrouped into wideband signals to generate seismic traces. Notably an greater (or “enhanced”) number of seismic traces can be generated based on there being a greater total number of seismic sensors. This can include seismic traces corresponding to the virtual and real seismic sensors of the virtual seismic sensor array, as opposed to only the real seismic sensors of the real seismic sensor array. The enhanced number of seismic traces can be used to generate enhanced seismic images.

Such processing introduces the virtual array concept to fourth-order direction-finding methods, allowing a seismic trace 133 to be formed for the virtual seismic array responsive to the steering vector of size (L²) and the fourth-order crosscumulants for the plurality of narrowband signals and the plurality of virtual steering vectors for each of the plurality of (I) statistically independent seismic signals. As has been shown with reference to FIG. 3A and FIG. 3B, the resolution of the resulting “enhanced” seismic trace 133 is enhanced in comparison to a corresponding seismic trace for the real seismic array. The operation of forming a seismic trace for the virtual seismic array responsive to fourth-order direction-finding algorithms for the virtual seismic array includes using the steering vector of size (L²) as a steering vector for each of the plurality of signal responses for each of the plurality of real seismic sensors to define a virtual seismic array having (L²) sensors.

In some embodiments, generating an enhanced seismic image based on the enhanced seismic traces (block 1614) includes using known seismic imaging techniques to assemble the enhanced seismic traces 133 to produce an enhanced seismic image 102 that is based on the seismic data 120 from both the virtual sensors and the real seismic sensors.

Accordingly, embodiments can present a series of processing steps (e.g., the steps of method 1600) before forming the seismic sensor arrays whereby additional seismic sensors are constructed from the real seismic sensors. The additional seismic information for the virtual seismic sensors are present in the steering vectors and is derived according to embodiments described herein. The additional virtual seismic sensors can advantageously enhance the resolution of the seismic sensor array response, reduce the number of real seismic sensors used in the seismic array, or both. As can be shown with reference to FIG. 2A, FIG. 3A, and FIG. 3B, the addition of the virtual seismic sensors to a the uniformly-spaced linear seismic sensor array having L real seismic sensors produces a virtual seismic sensor array having a (2L−1) real and virtual seismic sensors including different real and virtual sensors that are weighted in amplitude by a factor L−|p−q|, the response for which is amplitude-tapered and beneficially maintains the bandwidth of the virtual array of the real array, despite the fact that the physical size of the virtual seismic sensor array is two times greater than that of the real array.

In some embodiments, the data associated with virtual sensor array (e.g., the virtual sensor array data 126) is processed to generate an enhanced seismic image 102. This can include, for example, regularizing the virtual sensor array data (e.g., via application of a nonlinear interpolation formula or Lagrange formulas) to generate regularized data, generating seismic traces 133 using the regularized data, and generating an enhanced seismic image 102 using the seismic traces 133.

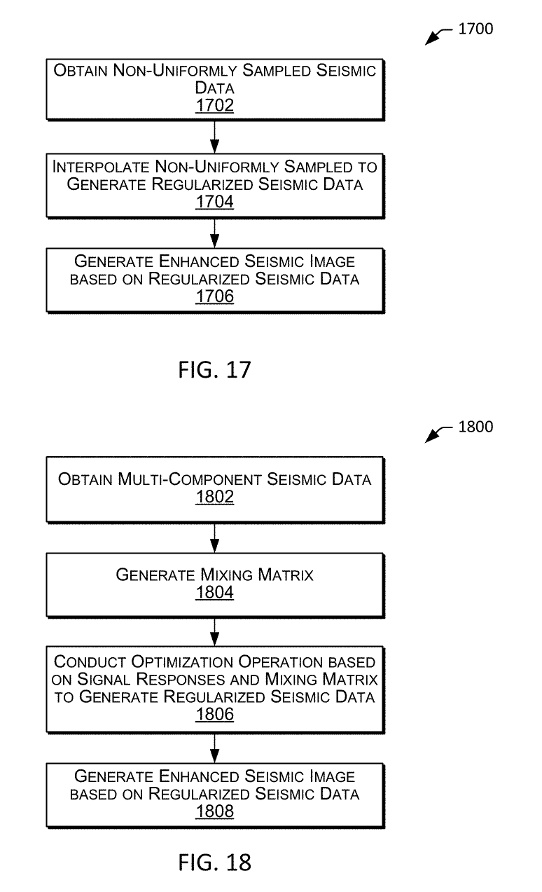

FIG. 17 is a flowchart that illustrates an example method 1700 for generating an enhanced seismic images utilizing data regularization in accordance with one or more embodiments. In some embodiments, method 1700 includes obtaining non-uniformly sampled seismic data (block 1702), interpolating the non-uniformly sampled seismic data to generate regularized seismic data (block 1704), and generating an enhanced seismic image based on the regularized seismic data (block 1706). In some embodiments, some or all of the operations of method 1700 are performed by the seismic processing system 113.

In some embodiments, obtaining non-uniformly sampled seismic data (block 1702) includes obtaining seismic data 120 comprising seismic signal responses 117 from real seismic sensors 112 of a non-uniform real seismic sensor array 118. The non-uniform real seismic sensor array 118 can include for example, a non-uniform distribution (e.g., a non-uniform liner, grid, circle or star distribution) of real seismic sensors 112, such as a distribution consistent with one of the real seismic sensor arrays 118b, 118c, 118d and 118e described herein with regard to at least FIGS. 2B-2E. In some embodiments, each of the signal responses 1117 includes multi-component recordings including one or more derivatives (e.g., 1^{st}, 2^{nd}, 3^{rd}, 4^{th}, 5^{th} and/or 6^{th} derivatives) of the components of the corresponding seismic echoes 116.

In some embodiments, interpolating the non-uniformly sampled seismic data to generate regularized seismic data (block 1702) can include conducting a Lagrange interpolation or a non-linear interpolation of the non-uniformly sampled seismic data to generate regularized seismic data 132 (e.g., representing a regular distribution of seismic sensors). In some embodiments, interpolating the non-uniformly sampled seismic data to generate regularized seismic data includes generating a virtual seismic sensor array including data corresponding to the real seismic sensors of the of the real seismic sensor array and virtual seismic sensors, as described herein, for example with regard to at least method 1600 of FIG. 16. For example, generating a virtual seismic sensor array can include generating a complex envelope for each seismic signal response 117 generated by the real seismic sensors 112, decomposing each complex envelope into one or more narrowband signals, determining fourth-order cross-cumulants for each of the narrowband signals for each of (I) statistically independent seismic signals, and determining a virtual steering vector for each of the each of the (I) statistically independent seismic signals based on the fourth-order cross-cumulants. In some embodiments, enhanced seismic traces can be generated based on the fourth-order cross-cumulants and the virtual steering vectors.

In some embodiments, generating an enhanced seismic image based on the regularized seismic data (block 1706) includes generating an enhanced seismic image 102 of the subsurface formation 104 using the regularized seismic data. In some embodiments, generating an enhanced seismic image 102 of the subsurface formation 104 includes generating enhanced seismic traces 133 using the regularized seismic data and assembling the enhanced seismic traces 133 to generate one or more enhanced seismic images 102 of the subsurface formations 104.

Accordingly, in some embodiments, (i) the seismic data is non-uniformly sampled seismic data with derivatives (e.g., with first-order derivative or with first and second order derivatives) or without derivatives; (ii) a virtual array is applied to the non-uniformly sampled seismic data to generate virtual seismic sensor array data; (iii) a nonlinear interpolation formula (or Lagrange formulas) is applied to the seismic data and/or the virtual seismic sensor array data, to generate regularized seismic data (e.g., using the wavefield and its derivatives if they are provided in the input data), and/or (iv) the regularized seismic data is used to generate enhanced seismic images of a formation.

In a first embodiment, (i) the seismic data is non-uniformly sampled data without their derivatives; and (ii) a virtual array is generated and applied to generate virtual seismic sensor array data, and a nonlinear interpolation formula is applied thereto to obtain regularized data, as described herein.

In a second embodiment, (i) the seismic data is non-uniformly sampled data without their derivatives; and (ii) a virtual array is generated and applied to generate virtual seismic sensor array data, and Lagrange formulas are applied thereto to obtain regularized data, as described herein.

In a third embodiment, (i) the seismic data is non-uniformly sampled data with first-order derivatives; and (ii) a virtual array is generated and applied to generate virtual seismic sensor array data for each data component, including their derivatives, and a nonlinear interpolation formula is applied thereto to obtain regularized data using the wavefield and its derivatives, as described herein.

In a fourth embodiment, (i) the seismic data is non-uniformly sampled data with first-order derivatives; and (ii) a virtual array is generated and applied to generate virtual seismic sensor array data for each data component, including their derivatives, and Lagrange formulas are applied thereto to obtain regularized data using the wavefield and its derivatives, as described herein.

In a fifth embodiment, (i) the seismic data is non-uniformly sampled data with first and second-order derivatives; (ii) a virtual array is generated and applied to generate virtual seismic sensor array data for each data component, including their derivatives, and a nonlinear interpolation formula is applied thereto to obtain regularized data using the wavefield and its derivatives, as described herein.

In a sixth embodiment, (i) the seismic data is non-uniformly sampled data with first and second-order derivatives; and (ii) a virtual array is generated and applied to generate virtual seismic sensor array data for each data component, including their derivatives, and Lagrange formulas (e.g., those above) are applied thereto to obtain regularized data using the wavefield and its derivatives, as described herein.

In a seventh embodiment, (i) the seismic data is non-uniformly sampled data without their derivatives; and (ii) a nonlinear interpolation formula is applied thereto to obtain regularized data.

In an eighth embodiment, (i) the seismic data is non-uniformly sampled data without their derivatives; and (ii) Lagrange formulas (e.g., those above) are applied thereto to obtain regularized data, as described herein.

In a ninth embodiment, (i) the seismic data is non-uniformly sampled data with first-order derivatives; and (ii) a nonlinear interpolation formula is applied thereto to obtain regularized data using the wavefield and its derivatives, as described herein.

In a tenth embodiment, (i) the seismic data is non-uniformly sampled data with first-order derivatives; and (ii) Lagrange formulas are applied thereto to obtain regularized data using the wavefield and its derivatives, as described herein.

In an eleventh embodiment, (i) the seismic data is non-uniformly sampled data with first and second-order derivatives; and (ii) a nonlinear interpolation formula is applied thereto to obtain regularized data using the wavefield and its derivatives, as described herein.

In a twelfth embodiment, (i) the seismic data is non-uniformly sampled data with first and second-order derivatives; and (ii) Lagrange formulas (e.g., those above) are applied thereto to obtain regularized data using the wavefield and its derivatives, as described herein.

In a thirteenth embodiment, (i) the seismic data is non-uniformly sampled data with n order derivatives (e.g., n>3); and (ii) a nonlinear interpolation formula is applied thereto to obtain regularized data using the wavefield and its derivatives, as described herein.

In a fourteenth embodiment, (i) the seismic data is non-uniformly sampled data with n order derivatives (e.g., n>3); and (ii) Lagrange formulas are applied thereto to obtain regularized data using the wavefield and its derivatives, as described herein.

In some embodiments, the resulting regularized data is processed to generate seismic traces of enhanced resolution (e.g., based on the regularized data being based on the seismic data acquired from the real seismic sensors and the virtual seismic sensor array data), and the seismic traces of enhanced resolution are assembled to generate an enhanced seismic image.

In some embodiments, specialized processing is conducted on the seismic data to generate regularized seismic data for sparse seismic sensors arrays formed of seismic sensors that are spaced from one another by relatively large distances. FIG. 18 is a flowchart that illustrates an example method 1800 for generating an enhanced seismic images in accordance with one or more embodiments. In some embodiments, method 1800 includes obtaining multi-component seismic data (block 1802), generating a mixing-matrix (block 1804), conducting an optimization operation based on the multi-component signal responses and the mixing-matrix to generate regularized seismic data (block 1806), and generating an enhanced seismic image based on the regularized seismic data (block 1808). In some embodiments, some or all of the operations of method 1800 are performed by the seismic processing system 113.

In some embodiments, obtaining multi-component seismic data (block 1802) includes obtaining seismic data 120 comprising seismic signal responses 117 from real seismic sensors 112 of a real seismic sensor array 118. The real seismic sensor array 118 can include a uniform or non-uniform real seismic sensor array 118. For example, the real seismic sensor array 118 can include a distribution consistent with one of the real seismic sensor arrays 118a, 118b, 118c, 118d and 118e described herein with regard to at least FIGS. 2A-2E. In some embodiments, each of the signal responses 117 includes multi-component recordings including one or more derivatives (e.g., 1^{st}, 2^{nd}, 3^{rd}, 4^{th}, 5^{th} and/or 6^{th} derivatives) of the components of the corresponding seismic echoes 116.

In some embodiments, generating a mixing-matrix that is time-independent (block 1804) includes generating a mixing-matrix (A) that is time-independent. The mixing-matrix (A) may be known, or can be constructed from a Lagrange interpolation or be recovered from statistical methods. The mixing-matrix (A) may be similar to mixing-matrix 700 described with regard to FIG. 7.

In some embodiments, conducting an optimization operation based on the multi-component signal responses and the mixing-matrix to generate regularized seismic data (block 1806) includes conducting a least-squares optimization operation or a sparse optimization operation to generate the regularized seismic data 132. In some embodiments, conducting an optimization operation includes generating a dictionary to increase a sparse representation of data and determining a second mixing-matrix (Ã) based on the mixing-matrix (A) and the dictionary. Such a dictionary may be similar to that of dictionary 1100 described with regard to FIG. 11A. Such a second mixing-matrix (Ã) may similar to mixing-matrix 1102 described with regard to FIG. 11B.

In some embodiments, generating an enhanced seismic image based on the regularized seismic data (block 1808) includes generating an enhanced seismic image 102 of the subsurface formation 104 using the regularized seismic data 132. In some embodiments, generating an enhanced seismic image 102 of the subsurface formation 104 includes generating enhanced seismic traces 133 using the regularized seismic data and assembling the enhanced seismic traces to generate one or more enhanced seismic images 102 of the subsurface formations 104.

The embodiments for acquiring and processing seismic data can provide for the generation of enhanced seismic images, which can in-turn be a key element in discovering and developing hydrocarbon reservoirs.

Accordingly, certain embodiments provide for generating virtual seismic sensors that can fill-in gaps between real seismic sensors of a real seismic sensor array, certain embodiments provide for regularizing data obtained via a non-uniform seismic sensor arrays, and certain embodiments provide for processing of seismic data obtained via sparse seismic sensor arrays. Embodiments can provide for generating regularized data (e.g., non-aliased data corresponding to a seismic sensor array having equidistant seismic sensor spacings) from non-uniform aliased data (e.g., aliased data acquired via a real seismic sensor array having uneven or non-equidistant seismic sensor spacings) and, in some embodiments, the real or virtual seismic sensor array can be sparse (e.g., the spacings of the seismic receivers of the array being relatively large). In some embodiments, one or more of the described techniques can be used in combination to account for non-uniform and/or sparse real seismic sensor arrays. For example, seismic data can be acquired via a non-uniform and sparse real seismic sensor array, virtual sensors can be generated to fill-in gaps in the real seismic sensors, data regularization can be applied to account for any irregularities in the real seismic sensor array, and compressive sensing can be applied to account for the sparse spacing of the real seismic sensor array.

In some embodiments, the virtual array techniques can be employed with seismic data, to fill-in gaps of a real seismic sensor array or to generate additional virtual seismic sensors, thereby providing for the generation of an enhanced seismic image in comparison with a seismic image that can be generated from the real seismic sensor array using existing techniques.

In some embodiments, the virtual array techniques can be employed in combination with the use of multi-component seismic data, the data regularization techniques (e.g., Lagrangian interpolation), and/or the compressive sensing techniques to increase the effective sampling of a real seismic sensor array, thereby providing for the generation of an enhanced seismic image in comparison with a seismic image that can be generated from the real seismic sensor array using existing techniques.

In some embodiments, the multi-component seismic data techniques can be employed in combination with the data regularization techniques (e.g., Lagrangian interpolation) and/or the compressive sensing techniques (e.g., without the use of virtual array techniques) to increase the effective sampling of a real seismic sensor array, thereby providing for the generation of an enhanced seismic image in comparison with a seismic image that can be generated from the real seismic sensor array using existing techniques.

In some embodiments, the data regularization techniques (e.g., Lagrangian interpolation) and the compressive sensing techniques (e.g., without the use of the virtual array techniques and/or the use of multi-component seismic data) can be used in combination or alone to increase the effective sampling of a real seismic sensor array, thereby providing for the generation of an enhanced seismic image in comparison with a seismic image that can be generated from the real seismic sensor array using existing techniques. Notably, the ability of the data regularization techniques and the compressive sensing techniques to be employed with single-component seismic data (or non-multi-component seismic data) may be based on the type of data acquired. For example, multi-component data may be acquired and used with 4^{th} order data (e.g., L₁ norm data), and multi-component data may not need to be acquired or used with higher that 4^{th} order data (e.g., L₀ norm data).

FIG. 19 is a diagram that illustrates an example computer system 2000 in accordance with one or more embodiments. In some embodiments, the system 2000 may be a programmable logic controller (PLC). The system 2000 may include a memory 2004, a processor 2006, and an input/output (I/O) interface 2008. The memory 2004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), bulk storage memory (e.g., CD-ROM and/or DVD-ROM, hard drives), and/or the like. The memory 2004 may include a non-transitory computer-readable storage medium having program instructions 2010 stored therein. The program instructions 2010 may include program modules 2012 that are executable by a computer processor (e.g., the processor 2006) to cause the functional operations described herein, including those of the methods 1500, 1600, 1700 and/or 1800.

The processor 2006 may be any suitable processor capable of executing/performing program instructions. The processor 2006 may include a central processing unit (CPU) that carries out program instructions (e.g., the program instructions of the program module(s) 2012) to perform the arithmetical, logical, and input/output operations described herein. The processor 2006 may include one or more processors. The I/O interface 2008 may provide an interface for communication with one or more I/O devices 2014, such as a joystick, a computer mouse, a keyboard, a display screen (e.g., an electronic display for displaying a graphical user interface (GUI)), and/or the like. The I/O devices 2014 may include one or more of the user input devices. The I/O devices 2014 may be connected to the I/O interface 2008 via a wired (e.g., Industrial Ethernet) or a wireless (e.g., Wi-Fi) connection. The I/O interface 2008 may provide an interface for communication with one or more external devices 2016, such as other computers, networks, and/or the like. In some embodiments, the I/O interface 2008 may include an antenna, a transceiver, and/or the like. In some embodiments, the external devices 2016 may include one or one or more seismic sources 110 and/or one or more real seismic sensors 112 (e.g., a real seismic sensor array 118).

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features of the embodiments may be utilized independently, all as would be apparent to one skilled in the art after having the benefit of this description of the embodiments. Changes may be made in the elements described herein without departing from the spirit and scope of the embodiments as described in the following claims. Headings used herein are for organizational purposes only and are not meant to be used to limit the scope of the description.

It will be appreciated that the processes and methods described herein are example embodiments of processes and methods that may be employed in accordance with the techniques described herein. The processes and methods may be modified to facilitate variations of their implementation and use. The order of the processes and methods and the operations provided therein may be changed, and various elements may be added, reordered, combined, omitted, modified, etc. Portions of the processes and methods may be implemented in software, hardware, or a combination thereof. Some or all of the portions of the processes and methods may be implemented by one or more of the processors/modules/applications described herein.

As used throughout this application, the word “may” is used in a permissive sense (i.e., meaning having the potential to), rather than the mandatory sense (i.e., meaning must). The words “include,” “including,” and “includes” mean including, but not limited to. As used throughout this application, the singular forms “a”, “an,” and “the” include plural referents unless the content clearly indicates otherwise. Thus, for example, reference to “an element” may include a combination of two or more elements. As used throughout this application, the phrase “based on” does not limit the associated operation to being solely based on a particular item. Thus, for example, processing “based on” data A may include processing based at least in part on data A and based at least in part on data B unless the content clearly indicates otherwise. As used throughout this application, the term “from” does not limit the associated operation to being directly from. Thus, for example, receiving an item “from” an entity may include receiving an item directly from the entity or indirectly from the entity (e.g., via an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

What is claimed is:

1. A seismic imaging system comprising:
a seismic energy source physically positioned proximate a subsurface formation, the seismic energy source configured to emit waves of seismic energy into the subsurface formation;
a non-uniform real seismic sensor array comprising an un-even distribution of real seismic sensors physically positioned proximate the subsurface formation, the real seismic sensors of the real seismic sensor array configured to sense seismic echoes comprising reflections of the waves of seismic energy emitted into the subsurface formation and to generate signal responses corresponding to the seismic echoes sensed by the real seismic sensors of the non-uniform real seismic sensor array; and
a seismic processing system comprising non-transitory computer readable storage medium comprising program instructions stored thereon that are executable by a processor to perform the following operations:
obtaining non-uniformly sampled seismic data comprising the signal responses corresponding to the seismic echoes sensed by the real seismic sensors of the non-uniform real seismic sensor array;
interpolating the non-uniformly sampled seismic data to generate regularized seismic data representing a regular distribution of seismic sensors; and
generating, using the regularized seismic data, a seismic image of the subsurface formation.

2. The system of claim 1, wherein interpolating the non-uniformly sampled seismic data to generate regularized seismic data representing a regular distribution of seismic sensors comprises conducting a Lagrange interpolation of the non-uniformly sampled seismic data to generate the regularized seismic data representing a regular distribution of seismic sensors.

3. The system of claim 1, wherein interpolating the non-uniformly sampled seismic data to generate regularized seismic data representing a regular distribution of seismic sensors comprises conducting a non-linear interpolation of the non-uniformly sampled seismic data to generate the regularized seismic data representing a regular distribution of seismic sensors.

4. The system of claim 1, wherein the signal responses comprise multi-component recordings comprising one or more derivatives of each component of multiple components of the seismic echoes.

5. The system of claim 4, wherein the one or more derivatives comprise a first-order derivative.

6. The system of claim 4, wherein the one or more derivatives comprise a first-order derivative and a second-order derivative.

7. The system of claim 4, wherein the one or more derivatives comprise a first-order derivative, a second-order derivative and a third-order derivative.

8. The system of claim 1, wherein interpolating the non-uniformly sampled seismic data to generate regularized seismic data representing a regular distribution of seismic sensors comprises generating a virtual seismic sensor array comprising data corresponding to the real seismic sensors of the of the real seismic sensor array and virtual seismic sensors.

9. The system of claim 8, wherein generating a virtual seismic sensors array comprising data corresponding to the real seismic sensors of the of the real seismic sensor array and virtual seismic sensors comprises:
generating a complex envelope for each seismic signal response generated by the real seismic sensors;
decomposing each complex envelope into one or more narrowband signals;
determining fourth-order cross-cumulants for each of the narrowband signals for each of (I) statistically independent seismic signals;
determining a virtual steering vector for each of the each of the (I) statistically independent seismic signals based on the fourth-order cross-cumulants; and
determining enhanced seismic traces from the fourth-order cross-cumulants and the virtual steering vectors,
wherein generating a seismic image of the subsurface formation comprises generating the seismic image of the subsurface formation based on the enhanced seismic traces.

10. The system of claim 1, wherein the non-uniform real seismic sensor array comprises a non-uniform linear distribution of the real seismic sensors.

11. The system of claim 1, wherein the non-uniform real seismic sensor array comprises a non-uniform two-dimensional grid distribution of the real seismic sensors.

12. The system of claim 1, wherein the non-uniform real seismic sensor array comprises a non-uniform two-dimensional circular distribution of the real seismic sensors comprising the real seismic sensors unevenly distributed about concentric circles.

13. The system of claim 1, wherein the non-uniform real seismic sensor array comprises a non-uniform two-dimensional star distribution of the real seismic sensors comprising the real seismic sensors unevenly distributed along radial lines.

14. A seismic imaging method comprising:
operating a seismic energy source physically positioned proximate a subsurface formation to emit waves of seismic energy into the subsurface formation;
operating a non-uniform real seismic sensor array to generate non-uniformly sampled seismic data, the real seismic sensor array comprising an un-even distribution of real seismic sensors physically positioned proximate the subsurface formation, the real seismic sensors of the real seismic sensor array configured to sense seismic echoes comprising reflections of waves of seismic energy emitted into the subsurface formation and to generate signal responses corresponding to the seismic echoes sensed by the real seismic sensors of the non-uniform real seismic sensor array, the non-uniformly sampled seismic data comprising the signal responses corresponding to the seismic echoes sensed by the real seismic sensors of the non-uniform real seismic sensor array; and
a seismic processing system performing the following operations:
obtaining the non-uniformly sampled seismic data comprising the signal responses corresponding to the seismic echoes sensed by the real seismic sensors of the non-uniform real seismic sensor array;
interpolating the non-uniformly sampled seismic data to generate regularized seismic data representing a regular distribution of seismic sensors; and
generating, using the regularized seismic data, a seismic image of the subsurface formation.

15. The method of claim 14, wherein interpolating the non-uniformly sampled seismic data to generate regularized seismic data representing a regular distribution of seismic sensors comprises conducting a Lagrange interpolation of the non-uniformly sampled seismic data to generate the regularized seismic data representing a regular distribution of seismic sensors.

16. The method of claim 14, wherein interpolating the non-uniformly sampled seismic data to generate regularized seismic data representing a regular distribution of seismic sensors comprises conducting a non-linear interpolation of the non-uniformly sampled seismic data to generate the regularized seismic data representing a regular distribution of seismic sensors.

17. The method of claim 14, wherein the signal responses comprise multi-component recordings comprising one or more derivatives of each component of multiple components of the seismic echoes.

18. The method of claim 17, wherein the one or more derivatives comprise a first-order derivative.

19. The method of claim 17, wherein the one or more derivatives comprise a first-order derivative and a second-order derivative.

20. The method of claim 17, wherein the one or more derivatives comprise a first-order derivative, a second-order derivative and a third-order derivative.

21. The method of claim 14, wherein interpolating the non-uniformly sampled seismic data to generate regularized seismic data representing a regular distribution of seismic sensors comprises generating a virtual seismic sensor array comprising data corresponding to the real seismic sensors of the of the real seismic sensor array and virtual seismic sensors.

22. The method of claim 21, wherein generating a virtual seismic sensors array comprising data corresponding to the real seismic sensors of the of the real seismic sensor array and virtual seismic sensors comprises:
generating a complex envelope for each seismic signal response generated by the real seismic sensors;
decomposing each complex envelope into one or more narrowband signals;
determining fourth-order cross-cumulants for each of the narrowband signals for each of (I) statistically independent seismic signals;
determining a virtual steering vector for each of the each of the (I) statistically independent seismic signals based on the fourth-order cross-cumulants; and
determining enhanced seismic traces from the fourth-order cross-cumulants and the virtual steering vectors,
wherein generating a seismic image of the subsurface formation comprises generating the seismic image of the subsurface formation based on the enhanced seismic traces.

23. The method of claim 14, wherein the non-uniform real seismic sensor array comprises a non-uniform linear distribution of the real seismic sensors.

24. The method of claim 14, wherein the non-uniform real seismic sensor array comprises a non-uniform two-dimensional grid distribution of the real seismic sensors.

25. The method of claim 14, wherein the non-uniform real seismic sensor array comprises a non-uniform two-dimensional circular distribution of the real seismic sensors comprising the real seismic sensors unevenly distributed about concentric circles.

26. The method of claim 14, wherein the non-uniform real seismic sensor array comprises a non-uniform two-dimensional star distribution of the real seismic sensors comprising the real seismic sensors unevenly distributed along radial lines.

27. A non-transitory computer readable medium comprising program instructions stored thereon that are executable by a processor to perform the following operations for seismic imaging:
obtaining non-uniformly sampled seismic data generated by real seismic sensor array, the real seismic sensor array comprising an un-even distribution of real seismic sensors physically positioned proximate a subsurface formation, the real seismic sensors of the real seismic sensor array sensing seismic echoes comprising reflections of waves of seismic energy emitted into the subsurface formation by a seismic energy source physically positioned proximate the subsurface formation and generating signal responses corresponding to the seismic echoes sensed by the real seismic sensors of the non-uniform real seismic sensor array, the non-uniformly sampled seismic data comprising the signal responses corresponding to the seismic echoes sensed by the real seismic sensors of the non-uniform real seismic sensor array;
interpolating the non-uniformly sampled seismic data to generate regularized seismic data representing a regular distribution of seismic sensors; and
generating, using the regularized seismic data, a seismic image of the subsurface formation.

28. A seismic imaging system comprising:
a seismic energy source physically positioned proximate a subsurface formation, the seismic energy source configured to emit waves of seismic energy into the subsurface formation;
a real seismic sensor array comprising real seismic sensors physically positioned proximate the subsurface formation, the real seismic sensors of the real seismic sensor array configured to sense seismic echoes comprising reflections of the waves of seismic energy emitted into the subsurface formation and to generate multi-component signal responses corresponding to the seismic echoes sensed by the real seismic sensors of the real seismic sensor array, the real seismic sensor array having a first spacing between the real seismic sensors of the real seismic sensor array; and
a seismic processing system configured to perform the following operations:
generating a mixing-matrix that is time-independent;
conducting an optimization operation based on the multi-component signal responses and the mixing-matrix to generate regularized seismic data corresponding to a seismic sensor array having a second spacing between the seismic sensors of the seismic sensor array that is less than the first spacing of the real seismic sensor array; and
generating a seismic image of the subsurface formation based on the regularized seismic data.

29. The system of claim 28, wherein the optimization operation comprises a least-squares optimization operation.

30. The system of claim 28, wherein the optimization operation comprises a sparse optimization operation.

31. The system of claim 28, wherein the operations further comprise:
generating a dictionary configured to increase a sparse representation of data;
determining a second mixing-matrix based on the mixing-matrix and the dictionary, and
wherein conducting an optimization operation based on the multi-component signal responses and the mixing-matrix to generate regularized seismic data comprises conducting an optimization operation based on the second mixing-matrix to generate reconstructed data and generating the regularized seismic data based on the dictionary and the reconstructed data.

32. The system of claim 31, wherein the optimization operation comprises a least-squares optimization operation.

33. The system of claim 31, wherein the optimization operation comprises a sparse optimization operation.

34. The system of claim 31, wherein the real seismic sensor array comprises a uniform seismic sensor array comprising an even distribution of real seismic sensors physically positioned proximate the subsurface formation.

35. The system of claim 31, wherein the real seismic sensor array comprises a non-uniform seismic sensor array comprising an un-even distribution of real seismic sensors physically positioned proximate the subsurface formation.

36. A seismic imaging method comprising:
operating a seismic energy source physically positioned proximate a subsurface formation to emit waves of seismic energy into the subsurface formation;
operating a real seismic sensor array to generate multi-component signal responses, the real seismic sensor array comprising real seismic sensors physically positioned proximate the subsurface formation, the real seismic sensors of the real seismic sensor array configured to sense seismic echoes comprising reflections of the waves of seismic energy emitted into the subsurface formation, the multi-component signal responses corresponding to the seismic echoes sensed by the real seismic sensors of the real seismic sensor array, the real seismic sensor array having a first spacing between the real seismic sensors of the real seismic sensor array; and
a seismic processing system performing the following operations:
generating a mixing-matrix that is time-independent;
conducting an optimization operation based on the multi-component signal responses and the mixing-matrix to generate regularized seismic data corresponding to a seismic sensor array having a second spacing between the seismic sensors of the seismic sensor array that is less than the first spacing of the real seismic sensor array; and
generating a seismic image of the subsurface formation based on the regularized seismic data.

37. The method of claim 36, wherein the optimization operation comprises a least-squares optimization operation.

38. The method of claim 36, wherein the optimization operation comprises a sparse optimization operation.

39. The method of claim 36, wherein the operations further comprise:
generating a dictionary configured to increase a sparse representation of data;
determining a second mixing-matrix based on the mixing-matrix and the dictionary, and
wherein conducting an optimization operation based on the multi-component signal responses and the mixing-matrix to generate regularized seismic data comprises conducting an optimization operation based on the second mixing-matrix to generate reconstructed data and generating the regularized seismic data based on the dictionary and the reconstructed data.

40. The method of claim 39, wherein the optimization operation comprises a least-squares optimization operation.

41. The method of claim 39, wherein the optimization operation comprises a sparse optimization operation.

42. The method of claim 36, wherein the real seismic sensor array comprises a uniform seismic sensor array comprising an even distribution of real seismic sensors physically positioned proximate the subsurface formation.

43. The method of claim 36, wherein the real seismic sensor array comprises a non-uniform seismic sensor array comprising an un-even distribution of real seismic sensors physically positioned proximate the subsurface formation.

44. A non-transitory computer readable medium comprising program instructions stored thereon that are executable by a processor to perform the following operations for seismic imaging:
obtaining multi-component signal responses generated by a real seismic sensor array, the real seismic sensor array comprising real seismic sensors physically positioned proximate a subsurface formation, the real seismic sensors of the real seismic sensor array sensing seismic echoes comprising reflections of waves of seismic energy emitted into the subsurface formation by a seismic energy source physically positioned proximate the subsurface formation and generating the multi-component signal responses, the multi-component signal responses corresponding to the seismic echoes sensed by the real seismic sensors of the real seismic sensor array, the real seismic sensor array having an first spacing between the real seismic sensors of the real seismic sensor array;
generating a mixing-matrix that is time-independent;
conducting an optimization operation based on the multi-component signal responses and the mixing-matrix to generate regularized seismic data corresponding to a seismic sensor array having a second spacing between the seismic sensors of the seismic sensor array that is less than the first spacing of the real seismic sensor array; and
generating a seismic image of the subsurface formation based on the regularized seismic data.
